(19) United States
(12) Patent Application Publication
(10) Pub. No.: US 2025/0229484 A1
(43) Pub. Date: Jul. 17, 2025

(54) SYSTEMS, METHODS, AND COMPOSITIONS FOR ADDITIVE MANUFACTURING

(71) Applicant: 3D Systems, Inc., Rock Hill, SC (US)

(72) Inventor: Khalil MOUSSA, Rock Hill, SC (US)

(21) Appl. No.: 19/028,885

(22) Filed: Jan. 17, 2025

Related U.S. Application Data
(60) Provisional application No. 63/621,811, filed on Jan. 17, 2024.

(51) Int. Cl. B29C 64/124; B33Y 10/00; B33Y 70/00; C08K 11/00

(52) U.S. Cl. CPC B29C 64/124; B33Y 10/00; B33Y 70/00; C08K 11/00

(57) ABSTRACT

In one aspect, a kit for use in additive manufacturing is provided, the kit comprising a first build material and a second build material, wherein the first build material and the second build material do not have identical chemical compositions, and wherein the first build material and the second build material have at least one property that differs by 10% or less. In another aspect, a method of printing a three-dimensional article is provided, the method comprising providing a first build material and a second build material, and selectively consolidating or solidifying layers of the first build material and layers of the second build material to form the 3D article.

### CROSS REFERENCE TO RELATED APPLICATIONS

This application claims priority pursuant to 35 U.S.C. § 119 to U.S. Provisional Patent Application No. 63/621,811, filed Jan. 17, 2024, which is hereby incorporated by reference in its entirety.

### FIELD

The present invention relates generally to systems, methods, and compositions for use in three-dimensional (3D) printing or additive manufacturing.

### BACKGROUND

Additive manufacturing, also known as solid freeform fabrication or rapid prototyping/manufacturing, includes many different techniques for forming three-dimensional objects or articles, including but not limited to selective deposition modeling, fused deposition modeling, film transfer imaging, stereolithography, selective laser sintering, selective laser melting, and others. For example, these techniques may form three-dimensional objects from computer aided design (CAD) data, or other data defining the object to be made, by depositing or consolidating build material(s) in a layer-by-layer fashion to build up the object.

“Build material” refers to any material which may be used in an additive manufacturing technique. Build materials are used to form various 3D objects, articles, or parts in accordance with the computer generated files or data. A build material can be used for one or more components of a 3D printed object (i.e., a portion or all of the 3D printed object).

Some commercially available 3D printers or additive manufacturing systems use build materials which are jetted through a print head as a liquid to form the various 3D objects, articles, or parts. In some instances, the build material is solid at ambient temperatures, and converts to liquid at elevated jetting temperatures. In other instances, the build material is liquid at ambient temperatures. Moreover, in some cases, the build material can be cured following dispensing and/or deposition thereof onto the substrate. Curing can be achieved using a laser or other source of electromagnetic radiation. Other 3D printers form 3D articles from a reservoir, vat, or container of a fluid ink or build material or a powdered ink or build material. In some cases, a binder material or a laser or other source is used to selectively solidify or consolidate layers of the build material in a stepwise fashion to provide the 3D article.

Multi-material 3D printing involves using more than one type of build material within a single print. However, multiple challenges exist when trying to provide 3D articles using multiple materials within a single printing process. For instance, for some printed parts, it may be necessary to perform material changes hundreds or thousands of times within a single print, which may be impossible or impractical for various reasons related to compositions and equipment.

### SUMMARY

The present disclosure, in some embodiments, provides various advantages compared to previous systems, methods, and compositions for additive manufacturing. In one aspect, kits for use in additive manufacturing are described herein. In another aspect, methods of printing 3D articles are disclosed. In still another aspect, printed 3D articles, objects, or parts are described in the present disclosure.

In some embodiments, a kit described herein comprises at least a first build material and a second build material, wherein the first build material and the second build material do not have identical chemical compositions. Additionally, the first build material and the second material can have certain properties that are the same or similar to one another, and certain other properties that are not the same or similar. For example, in some cases, the first build material and the second build material have at least one property that differs by at least 20%, when both build materials are consolidated as part of an additive manufacturing process (e.g., when both build materials are cured, sintered, or fused). The differing property or properties can be one or more mechanical, thermal, or optical properties, as described further herein.

Likewise, the differing build materials can have one or more features or properties that are the same or similar. For example, in some such cases, the first build material has a first surface tension and/or first wettability at a temperature (denoted as “T”), and the second build material has a second surface tension and/or second wettability at the temperature T, and the first surface tension and/or first wettability and the second surface tension and/or second wettability, respectively, differ by 10% or less. Additionally, in some implementations, the first build material also has a first chemical reactivity at the temperature T, a first melting point onset temperature, and/or a first total optical absorbance or light penetration depth at a wavelength denoted as “2” (e.g., a specific wavelength in the range of 300-900 nm or 400-700 nm), and the second build material has a second chemical reactivity at the temperature T, a second melting point onset temperature, and/or a second total optical absorbance or light penetration depth at the wavelength λ. In some such cases, the first chemical reactivity at the temperature T, the first melting point onset temperature, and/or the first total optical absorbance or light penetration depth at the wavelength λ, and the second chemical reactivity at the temperature T, the second melting point onset temperature, and/or the second total optical absorbance or light penetration depth at the wavelength λ, respectively, differ by 10% or less.

Selecting or combining build materials as described above can, in some cases, permit multiple different build materials to be used to form a single 3D article in the same printing process without changing printing parameters when “switching” between materials. Moreover, in some such embodiments, the resulting 3D article can comprise or have multiple distinct regions that have different properties, such as different mechanical, thermal, and/or optical properties, despite the use of only one set of printing parameters. Kits and methods described herein can thus permit multi-material printing in an efficient manner, while also providing printed 3D articles having complex properties, particularly properties that vary spatially within the volume of the printed 3D article in a pre-determined and controlled manner.

Moreover, as described further herein, the properties or features of different build materials that are the same or similar, and the properties or features of different build materials that are not the same or similar, can be selected or determined based on the method of additive manufacturing used. For instance, as described further herein, the properties or features of a first build material and second build material that are selected to be the same or similar in the case of photocurable material systems may differ from the properties that are selected to be the same or similar in the case of fused deposition modeling (FDM), selective laser sintering (SLS), or fluid-binder-on-powder (binder jetting) methods.

In addition, kits and methods described herein are not necessarily limited to only two different build materials. Any desired number of build materials can be used in a kit or method according to the present disclosure, and the various build materials can be selected such that they together provide the ability to print complex objects having complex property profiles in a single printing process, without the need to change print parameters when switching from one build material to another. For example, in some cases, a kit described herein further comprises n additional build materials having n additional properties that differ between build materials by 10% or less, and n additional properties that differ by at least 20% or more, when compared to at least one other build material used in the kit or method. It is also possible, in some cases, for the first build material to be referred to as a “base material” or “base” build material, such that each of the other build materials used in the kit, method, or system have similar or different properties relative to the base material (e.g., as described above based on percentage differences between specific properties). It is to be understood that in such combinations of build materials in a kit, method, or system described herein, the various build materials can have the same mode of consolidation (e.g., the build materials are each photopolymerizable, or each sinterable, etc.).

Thus, in another aspect, methods of printing a 3D article are described herein. In some such embodiments, a method of printing comprises providing at least a first build material and a second build material, and selectively consolidating or solidifying layers of the first build material and layers of the second build material to form the article. Further, in some embodiments, selectively consolidating or solidifying layers of the first build material and layers of the second build material comprises forming regions of a first type and regions of a second type within the article, wherein the regions of the first type and the regions of the second type have at least one property that differs by at least 20%. In some such cases, the regions of the first type and the regions of the second type also have at least one property that differs by less than 10%.

As described further herein, in some implementations, the build materials are provided in a layer-by-layer process. Additionally, the build materials can be selectively consolidated or solidified according to preselected computer aided design (CAD) parameters or other digital data or parameters corresponding to the desired final object. Moreover, in some embodiments, layers of the first build material and layers of the second build material are selectively consolidated or solidified using the same printing parameters.

As indicated above and as described further hereinbelow, the printing parameters used in a given instance (and the set of build materials used in a given instance) may vary, depending on the type of additive manufacturing. For instance, in some embodiments, selectively consolidating or solidifying layers of the first build material and layers of the second build material comprises selectively photocuring a portion of the first build material and selectively photocuring a portion of the second build material using incident curing radiation having a Gaussian distribution of wavelengths and a peak wavelength at the wavelength λ. In other instances, the first build material is retained in a fluid state in a first container, and the second build material is retained in a fluid state in a second container, and selectively consolidating or solidifying layers of the first build material and layers of the second build material comprises sintering the layers of the first build material and the layers of the second build material. In still another example, selectively consolidating or solidifying layers of the first build material and layers of the second build material comprises depositing layers of the first build material and layers of the second build material in a molten or fluid state and subsequently freezing or partially freezing the layers of the first build material and the layers of the second build material.

Additionally, in some cases, a method described herein uses more than two build materials. For example, in some embodiments, a method described herein further comprises providing n additional build material(s), and selectively consolidating or solidifying layers of the n additional build material(s) to form the article. In some embodiments, the n additional build materials do not have the same chemical compositions as the first build material, the second build material, or one another, and n is an integer ranging from 1 to 100.

In another aspect, printed three-dimensional articles are described herein. Such an article, in some embodiments, can be formed using kits and/or methods of the present disclosure.

In still another aspect, systems for additive manufacturing are described herein, wherein the system comprises a plurality of build materials as described herein.

These and other embodiments are further described in the following detailed description.

### BRIEF DESCRIPTION OF THE DRAWINGS

FIG. 1 graphically illustrates exemplary working curves according to one embodiment described herein.

FIG. 2 graphically illustrates exemplary working curves according to one embodiment described herein.

FIG. 3 graphically illustrates exemplary working curves according to one embodiment described herein.

FIG. 4 illustrates exemplary working curves according to some embodiments described herein.

### DETAILED DESCRIPTION

Embodiments described herein can be understood more readily by reference to the following detailed description and examples. Elements, apparatus and methods described herein, however, are not limited to the specific embodiments presented in the detailed description and examples. It should be recognized that these embodiments are merely illustrative of the principles of the present disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, 1 to 4, 3 to 7, 4.7 to 10.0, 3.6 to 7.9, or 5 to 8.

All ranges disclosed herein are also to be considered to include the end points of the range, unless expressly stated otherwise. For example, a range of “between 5 and 10,” “from 5 to 10,” or “5-10” should generally be considered to include the end points 5 and 10.

Further, when the phrase “up to” is used in connection with an amount or quantity, it is to be understood that the amount is at least a detectable amount or quantity (that is, the amount is a non-zero amount). For example, a material present in an amount “up to” a specified amount can be present from a detectable (or non-zero) amount and up to and including the specified amount.

It is also to be understood that the article “a” or “an” refers to “at least one,” unless the context of a particular use requires otherwise.

As used herein, the term “and/of” includes any and all combinations of one or more of the associated listed items.

As used herein, the terms “comprise”, “comprises”, “containing”; “has”, “have”, “having”, and “includes”, “include” and “including” are open-ended transition terms used to transition from a subject recited before the term to one or more elements recited after the term, where the element or elements listed after the transition term are not necessarily the only elements that make up the subject.

The term weight percent or wt. % means the weight of a given material relative to the weight of a resulting composition which includes the given material. For example, a composition comprising 10 wt. % of a component means that the composition includes 10 parts by weight of the component relative to 100 parts of the total weight of the resulting composition.

The terms “three-dimensional printing system,” “three-dimensional printer,” “printing,” and the like generally describe various solid freeform fabrication techniques for making three-dimensional articles or objects by stereolithography, selective laser sintering, selective deposition, jetting, fused deposition modeling, multi-jet modeling, digital light processing, liquid crystal display additive manufacturing, continuous liquid interface production, two-photon 3D printing, holographic 3D printing, and other additive manufacturing techniques now known in the art or that may be known in the future that use a build material to fabricate three-dimensional objects.

Unless otherwise defined, all terms (including technical and scientific terms) used herein have the same meaning as commonly understood by one having ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that a number of techniques, components, and steps are disclosed. Each of these has individual benefit and each can also be used in conjunction with one or more, or in some cases all, of the other disclosed techniques. Accordingly, for the sake of clarity, this description will refrain from repeating every possible combination of the individual steps or components in an unnecessary fashion. Nevertheless, the specification and claims should be read with the understanding that such combinations are entirely within the scope of the invention and the claims.

### I. Kits for Additive Manufacturing

In one aspect, a kit for use in additive manufacturing is provided. The kit may be employed in a variety of additive manufacturing processes, such as, for example, photocuring 3D printing (including stereolithography (SLA), digital light processing (DLP), liquid crystal display (LCD), multi-jet printing (MJP), continuous liquid interface production (CLIP), two-photon 3D printing (TPP), holographic 3D printing, and other photopolymerization printing technologies), fused deposition modeling (FDM), selective laser sintering (SLS), selective laser melting (SLM), and binder jetting (“fluid-binder-on-powder” systems), among others. As described herein, in some embodiments, a kit allows for multiple build materials to be used in conjunction with one another during a single print job.

In some embodiments, a kit described herein comprises at least a first build material (which may also be referred to as a “base material”) and a second build material. In some embodiments, the first build material and the second build material do not have identical chemical compositions. As such, in some embodiments, at least one property of a printed part (or region of a printed part) made using the first build material of the kit differs from that of another printed part (or region of a printed part) made using the second build material of the kit.

In some embodiments, a kit described herein allows for printing parameters to remain unchanged when switching between build materials. For instance, in some embodiments, the first build material and the second build material are selected so as to have at least one property that differs from each other by 10% or less. In some embodiments, the first build material and the second build material are selected so as to have at least one property that differs from each other by 9% or less, 8% or less, 7% or less, 6% or less, 5% or less, 4% or less, 3% or less, 2% or less, or 1% or less. In some embodiments, the first build material and the second build material have more than one property that differs from each other by 10% or less, 9% or less, 8% or less, 7% or less, 6% or less, 5% or less, 4% or less, 3% or less, 2% or less, or 1% or less.

Any property not inconsistent with the objectives of the present disclosure may be selected as the one or more properties that differ between the first build material and the second build material by 10% or less. In some embodiments, the one or more properties that are the same or similar (e.g., within 10%) are related to surface energy and/or inter-material reactivity or binding, such that the differing build materials can be consolidated together (including, e.g., in adjacent layers) without delaminating from one another in the final printed part. Thus, the one or more features or properties that are the same or similar between differing build materials (e.g., between a first build material and a second build material, or between a base material and an nth build material) are selected based on the type of additive manufacturing.

For instance, in the case of FDM, one or more of the following properties or features may, in some embodiments, be the same or similar between two build materials (e.g., between a first build material and a second build material, or between a base material and an nth build material): (i) surface tension at a printing temperature, (ii) surface tension at 25° C., and (iii) phase transition temperature. Thus, in some embodiments, the first build material of a kit described herein has a first surface tension at a printing temperature, a first surface tension at 25° C., and/or a first phase transition temperature, and the second build material has a second surface tension at the printing temperature, a second surface tension at 25° C., and/or a second phase transition temperature, wherein the first surface tension at the printing temperature and/or the first surface tension at 25° C. differ from the second surface tension at the printing temperature and/or the second surface tension at 25° C., respectively by 10% or less, 9% or less, 8% or less, 7% or less, 6% or less, 5% or less, 4% or less, 3% or less, 2% or less, or 1% or less. Similarly, in some instances, the first phase transition temperature differs from the second phase transition temperature by 5° C. or less, 3° C. or less, or 1° C.

As another example, in the case of SLS, one or more of the following properties or features may, in some instances, be the same or similar between two build materials (e.g., between a first build material and a second build material, or between a base material and an nth build material): (i) sintering temperature/window, (ii) absorption/reflection of the relevant laser light (for heating to the sintering temperature), and (iii) average particle size. Thus, in some non-limiting example embodiments, the first build material of a kit described herein has a first sintering temperature or temperature range, a first absorption or reflection of laser light at a given peak wavelength, and/or a first average particle size, and the second build material has a second sintering temperature or temperature range, a second absorption or reflection of a laser light, and/or a second average particle size. In some such cases, the first sintering temperature or temperature range and the second sintering temperature or temperature range differ by 15° C. or less, 10° C. or less, or 5° C. or less. Similarly, in some embodiments, the first build material has a first melting point onset temperature, the second build material has a second melting point onset temperature, and the first onset temperature and the second onset temperature differ by 10° C. or less, 7° C. or less, or 5° C. or less. Moreover, in some instances, the first and second absorption or reflection of laser light and/or the first and second average particle size, respectively, differ by 10% or less, 9% or less, 8% or less, 7% or less, 6% or less, 5% or less, 4% or less, 3% or less, 2% or less, or 1% or less.

As still another example, in the case of fluid-binder-on-powder systems, one or more of the following properties or features may, in some implementations, be the same or similar between two build materials (e.g., between a first build material and a second build material, or between a base material and an nth build material): (i) average particle size and (ii) wettability of the powder relative to the binder, or chemical reactivity between the powder and binder. Thus, in some implementations, the first build material of a kit described herein has a first average particle size, first wettability of powder relative to a binder, and/or first chemical reactivity between the powder and binder, and the second build material has a second average particle size, second wettability of powder relative to the binder, and/or second chemical reactivity between the powder and binder. In some such instances, the first average particle size, first wettability of powder relative to binder, and/or first chemical reactivity between the powder and binder, and the second average particle size, second wettability of powder relative to binder, and/or second chemical reactivity between the powder and binder, respectively, can differ by 10% or less, 9% or less, 8% or less, 7% or less, 6% or less, 5% or less, 4% or less, 3% or less, 2% or less, or 1% or less. In some embodiments, the first build material has a first chemical reactivity at a temperature T, the second build material has a second chemical reactivity at the temperature T, and the first chemical reactivity at the temperature T and the second chemical reactivity at the temperature T differ by 10% or less, 9% or less, 8% or less, 7% or less, 6% or less, 5% or less, 4% or less, 3% or less, 2% or less, or 1% or less.

As yet another example, in some preferred embodiments, a kit described herein is used in an additive manufacturing method that forms printed articles using photocuring. In some such embodiments, the first build material has a first surface tension at a temperature T, and the second build material has a second surface tension at the temperature T, and the first surface tension and the second surface tension differ by 10% or less, 9% or less, 8% or less, 7% or less, 6% or less, 5% or less, 4% or less, 3% or less, 2% or less, or 1% or less. Additionally, in some implementations, the first build material has a first total optical absorbance or light penetration depth at a wavelength λ, the second build material has a second total optical absorbance or light penetration depth at the wavelength λ, and the first total optical absorbance or light penetration depth at the wavelength, and the second total optical absorbance or light penetration depth at the wavelength λ differ by 10% or less, 9% or less, 8% or less, 7% or less, 6% or less, 5% or less, 4% or less, 3% or less, 2% or less, or 1% or less.

Additionally, in some implementations particularly relevant to photocuring (e.g., photocuring in which the printed part is surrounded or encased by non-cured build material, as the part is being formed in the printing process), the first build material additionally has a first photocuring working curve at the wavelength λ, and the second build material has a second photocuring working curve at the wavelength λ. In some especially preferred embodiments, the first photocuring working curve and the second photocuring working curve intersect, such as within a specific range or “window,” as described further hereinbelow.

Photocuring working curves are described in detail by Paul F. Jacobs, Rapid Prototyping & Manufacturing: Fundamentals of Stereolithography (Society of Manufacturing Engineers, McGraw-Hill, 1992) (first edition) (hereinafter referred to as “Jacobs”), incorporated herein by reference in its entirety.

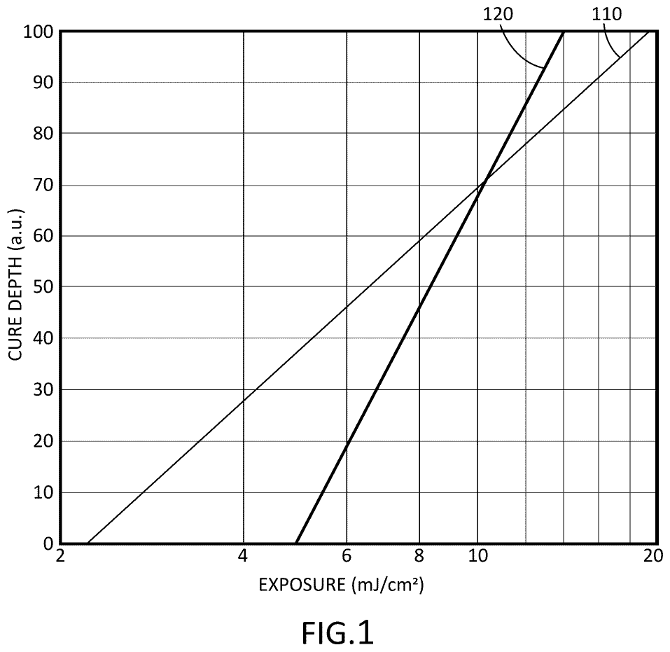

FIG. 1 shows two exemplary working curves, and exemplifies the fundamental working curve equation described by Jacobs:

$${C}_{d} = {D}_{p} ln [ {E}_{m ax} / {E}_{c} ] . \qquad Equation ( 1 )$$

In Equation (1), Cd represents the maximum cure depth of a single laser cured string. Dₚ represents the penetration depth of the resin or build material at the laser wavelength λ. Eₘₐₓ represents the maximum actinic laser exposure, and E_{c} represents the critical energy, or critical exposure of the build material or resin, at the laser wavelength λ. A discussion of the “structural” or “compositional” nature of these values can be found, for instance, in Chapter 4 of Jacobs. As understood by one of ordinary skill in the art, the value Dₚ (penetration depth) is defined as that depth of the resin or build material which results in a reduction of irradiance to a level equal to 1/e of the surface irradiance, where e is the base of natural logarithms (equal to 2.7182818 . . . ). E_{c} (critical energy) is defined as the energy needed to obtain the gel point of a build material or resin (see also page 86 of Jacobs). Moreover, as further described by Jacobs (pages 86-89), and as shown in FIG. 1, the metric E_{c} is equal to the intercept of a working curve corresponding to a semilog plot of cure depth on the ordinate and the logarithm of maximum radiation exposure on the abscissa. E_{c} is assigned to the intercept, at which the cure depth is zero. Further, the metric Dₚ is equal to the slope of the working curve. In FIG. 1, for illustration purposes, the cure depth on the ordinate (or y-axis) is provided in arbitrary units (a.u.) rather than in mils as is standard (where a mil is one-thousandth of an inch, or 0.0254 mm).

As illustrated in FIG. 1, the first working curve (110) intersects the second working curve (120). For illustration purposes, the first working curve (110) of FIG. 1 can be associated with a first build material, and the second working curve (120) of FIG. 1 can be associated with a second build material. Further, since both Dₚ and E_{c} are resin parameters, the slope and the intercept of the working curves described above are independent of laser power P_{L}, laser spot size W_{O}, and/or laser scan velocity Vₛ.

Moreover, in some embodiments, and as illustrated in FIG. 1, the first build material of a kit described herein has a first Dₚ at the wavelength λ, and a first E_{c} at the wavelength λ, and the second build material has a second Dₚ at the wavelength λ, and a second E_{c} at the wavelength λ. Moreover, in some embodiments, each build material independently has a Dₚ within a specific range, and each build material independently has an E_{c} within a specific range. For example, in some embodiments, the first Dₚ is between 2 and 7 mils; the second Dₚ is between 4 and 10 mils; the first E_{c} is between 2 and 10 mJ/cm²; and the second E_{c} is between 4 and 15 mJ/cm². Other possible combinations are further described hereinbelow.

For example, in some implementations, (1) the first Dₚ is between 2 and 10 mils, the second Dₚ is between 4 and 8 mils, the first E_{c} is between 2 and 15 mJ/cm², and the second E_{c} is between 4 and 15 mJ/cm²; (2) the first Dₚ is between 4 and 10 mils, the second Dₚ is between 4 and 8 mils, the first E_{c} is between 5 and 15 mJ/cm², and the second E_{c} is between 6 and 15 mJ/cm²; (3) the first Dₚ is between 2 and 7 mils, the second Dₚ is between 4 and 10 mils, the first E_{c} is between 2 and 10 mJ/cm², and the second E_{c} is between 4 and 15 mJ/cm²; (4) the first Dₚ is between 4 and 8 mils, the second Dₚ is between 4 and 8 mils, the first E_{c} is between 2 and 15 mJ/cm², and the second E_{c} is between 4 and 15 mJ/cm²; (5) the first Dₚ is between 4 and 7 mils, the second Dₚ is between 3 and 7 mils, the first E_{c} is between 2 and 20 mJ/cm², and the second E_{c} is between 4 and 25 mJ/cm²; (6) the first Dₚ is between 5 and 8 mils, the second Dₚ is between 5 and 8 mils, the first E_{c} is between 2 and 15 mJ/cm², and the second E_{c} is between 4 and 15 mJ/cm²; or (7) the first Dₚ is between 4 and 8 mils, the second Dₚ is between 5 and 10 mils, the first E_{c} is between 2 and 20 mJ/cm², and the second E_{c} is between 4 and 25 mJ/cm².

Moreover, in some cases, the first Dₚ and the second Dₚ differ by no more than a specific amount or percentage (calculated based on using the larger value as the denominator), such as no more than 20% or no more than 15%. In some instances, the first Dₚ and the second Dₚ differ by no more than 1 mil (e.g., the first and second Dₚ differ by 0 to 1 mil, 0 to 0.9 mil, 0 to 0.8 mil, 0 to 0.5 mil, 0.1 to 1 mil, 0.1 to 0.9 mil, or 0.1 to 0.8 mil). Similarly, in some embodiments, the first E_{c} and the second E_{c} differ by no more than a specific amount or percentage, such as no more than 20% or no more than 15%.

In some embodiments, the first Dₚ is between 2 mils and 7 mils. In some embodiments, the first Dₚ is 2.5-7 mils, 3-7 mils, 3.5-7 mils, 4-8 mils, 4.5-7 mils, 5-7 mils, 5.5-7 mils, 6-7 mils, 6.5-7 mils, 2-6 mils, 2.5-6 mils, 3-6 mils, 3.5-6 mils, 4-6 mils, 4.5-6 mils, 5-6 mils, 5.5-6 mils, 2-5 mils, 2.5-5 mils, 3-5 mils, 3.5-5 mils, 4-5 mils, 4.5-5 mils, 2-4 mils, 2.5-4 mils, 3-4 mils, 3.5-4 mils, 2-3 mils, or 2.5-3 mils.

Moreover, in some embodiments, the second Dₚ is between 4 mils and 10 mils. In some embodiments, the second Dₚ is within the range of 4.5-10 mils, 5-10 mils, 5.5-10 mils, 6-10 mils, 6.5-10 mils, 7-10 mils, 7.5-10 mils, 8-10 mils, 8.5-10 mils, 9-10 mils, 4-9 mils, 4.5-9 mils, 5-9 mils, 5.5-9 mils, 6-9 mils, 6.5-9 mils, 7-9 mils, 7.5-9 mils, 8-9 mils, 8.5-9 mils, 4-8 mils, 4.5-8 mils, 5-8 mils, 5.5-8 mils, 6-8 mils, 6.5-8 mils, 7-8 mils, 7.5-8 mils, 4-7 mils, 4.5-7 mils, 5-7 mils, 5.5-7 mils, 6-7 mils, 6.5-7 mils, 4-6 mils, 4.5-6 mils, 5-6 mils, or 5.5-6 mils.

In still other embodiments, both the first Dₚ and the second Dₚ are between 2 and 8 mils, between 2 and 10 mils, between 4 and 8 mils, between 4 and 7 mils, or between 5 and 8 mils.

Further, in some embodiments, the first E_{c} is between 2 and 10 mJ/cm². In some embodiments, the first E_{c} is within the range of 2.5-10 mJ/cm², 3-10 mJ/cm², 3.5-10 mJ/cm², 4-10 mJ/cm², 4.5-10 mJ/cm², 5-10 mJ/cm², 5.5-10 mJ/cm², 6-10 mJ/cm², 6.5-10 mJ/cm², 7-10 mJ/cm², 7.5-10 mJ/cm², 8-10 mJ/cm², 8.5-10 mJ/cm², 9-10 mJ/cm², 2-9 mJ/cm², 2.5-9 mJ/cm², 3-9 mJ/cm², 3.5-9 mJ/cm², 4-9 mJ/cm², 4.5-9 mJ/cm², 5-9 mJ/cm², 5.5-9 mJ/cm², 6-9 mJ/cm², 6.5-9 mJ/cm², 7-9 mJ/cm², 7.5-9 mJ/cm², 8-9 mJ/cm², 8.5-9 mJ/cm², 2-8 mJ/cm², 2.5-8 mJ/cm², 3-8 mJ/cm², 3.5-8 mJ/cm², 4-8 mJ/cm², 4.5-8 mJ/cm², 5-8 mJ/cm², 5.5-8 mJ/cm², 6-8 mJ/cm², 6.5-8 mJ/cm², 7-8 mJ/cm², 7.5-8 mJ/cm², 2-7 mJ/cm², 2.5-7 mJ/cm², 3-7 mJ/cm², 3.5-7 mJ/cm², 4-7 mJ/cm², 4.5-7 mJ/cm², 5-7 mJ/cm², 5.5-7 mJ/cm², 6-7 mJ/cm², or 6.5-7 mJ/cm².

In some embodiments, the second E_{c} is between 4 and 15 mJ/cm². In some embodiments, the second E_{c} is within the range of 4.5-15 mJ/cm², 5-15 mJ/cm², 5.5-15 mJ/cm², 6-15 mJ/cm², 6.5-15 mJ/cm², 7-15 mJ/cm², 7.5-15 mJ/cm², 8-15 mJ/cm², 8.5-15 mJ/cm², 9-15 mJ/cm², 9.5-15 mJ/cm², 10-15 mJ/cm², 4-14 mJ/cm², 4.5-14 mJ/cm², 5-14 mJ/cm², 5.5-14 mJ/cm², 6-14 mJ/cm², 6.5-14 mJ/cm², 7-14 mJ/cm², 7.5-14 mJ/cm², 8-14 mJ/cm², 8.5-14 mJ/cm², 9-14 mJ/cm², 9.5-14 mJ/cm², 10-14 mJ/cm², 4-13 mJ/cm², 4.5-13 mJ/cm², 5-13 mJ/cm², 5.5-13 mJ/cm², 6-13 mJ/cm², 6.5-13 mJ/cm², 7-13 mJ/cm², 7.5-13 mJ/cm², 8-13 mJ/cm², 8.5-13 mJ/cm², 9-13 mJ/cm², 9.5-13 mJ/cm², 10-13 mJ/cm², 4-12 mJ/cm², 4.5-12 mJ/cm², 5-12 mJ/cm², 5.5-12 mJ/cm², 6-12 mJ/cm², 6.5-12 mJ/cm², 7-12 mJ/cm², 7.5-12 mJ/cm², 8-12 mJ/cm², 8.5-12 mJ/cm², 9-12 mJ/cm², 9.5-12 mJ/cm², 10-12 mJ/cm², 4-11 mJ/cm², 4.5-11 mJ/cm², 5-11 mJ/cm², 5.5-11 mJ/cm², 6-11 mJ/cm², 6.5-11 mJ/cm², 7-11 mJ/cm², 7.5-11 mJ/cm², 8-11 mJ/cm², 8.5-11 mJ/cm², 9-11 mJ/cm², 9.5-11 mJ/cm², 10-11 mJ/cm², 4-10 mJ/cm², 4.5-10 mJ/cm², 5-10 mJ/cm², 5.5-10 mJ/cm², 6-10 mJ/cm², 6.5-10 mJ/cm², 7-10 mJ/cm², 7.5-10 mJ/cm², 8-10 mJ/cm², 8.5-10 mJ/cm², 9-10 mJ/cm², or 9.5-10 mJ/cm².

In still other embodiments, both the first E_{c} and the second E_{c} are between 2 and 10 mJ/cm², between 2 and 15 mJ/cm², between 2 and 20 mJ/cm², between 3 and 15 mJ/cm², between 4 and 15 mJ/cm², between 4 and 25 mJ/cm², between 5 and 15 mJ/cm², or between 6 and 15 mJ/cm².

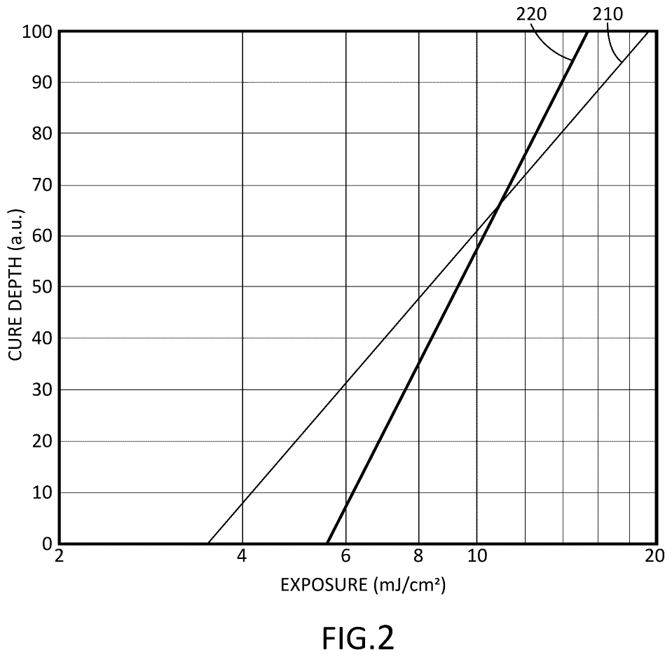

Turning again to the figures, FIG. 2 illustrates additional working curves according to some embodiments described herein, which may be considered to be an alternative to the embodiment illustrated in FIG. 1. As illustrated in FIG. 2, a first build material (not shown) has or is associated with a first working curve (210). The first working curve (210) is at a first wavelength λ₁. Additionally, a second build material (not shown) has or is associated with a second working curve (220). The second working curve (220) is at a second wavelength λ₂, which differs from the first wavelength λ₁. It is to be understood that the first working curve (210) and the second working curve (220) are illustrated in FIG. 2 on the same axes. This depiction is for convenience and does not indicate that the first working curve (210) and the second working curve (220) correspond to the same wavelength of curing radiation (that is, the same λ). Indeed, unlike in FIG. 1 (in which both illustrated working curves correspond to or are associated with the same wavelength λ as described above), the working curves in FIG. 2 correspond to different wavelengths of curing radiation. Namely, the first working curve (210) is associated with a first wavelength λ₁ and the second working curve (220) is associated with a second wavelength λ₂ that differs from λ₁. In some cases, the difference between λ₁ and λ₂ is at least 10 nm, at least 20 nm, or at least 30 nm. In some embodiments, the difference between λ₁ and λ₂ is no more than 200 nm, no more than 100 nm, no more than 50 nm, or no more than 30 nm. In some instances, the difference between λ₁ and λ₂ is 10-200 nm, 10-100 nm, 10-50 nm, 20-200 nm, 20-100 nm, 20-50 nm, 50-200 nm, or 50-100 nm.

However, despite being associated with different wavelengths (λ₁ and λ₂), the first working curve (210) and the second working curve (220) also intersect when plotted on the same axes (as do the two working curves in FIG. 1). Additionally, the first working curve (210) and the second working curve (220) can each have Dₚ and E_{c} values similar to those described above in the context of the first working curve (110) and the second working curve (120) of FIG. 1. Additionally, as in FIG. 1, since both Dₚ and E_{c} are resin parameters, the slope and the intercept of the working curves illustrated in FIG. 2 are independent of laser power P_{L}, laser spot size W_{O}, and/or laser scan velocity Vₛ.

Thus, in some embodiments, and as illustrated in FIG. 2, the first build material of a kit described herein has a first Dₚ at a first wavelength λ₁, and a first E_{c} at the wavelength λ₁, and the second build material has a second Dₚ at a wavelength λ₂, and a second E_{c} at the wavelength λ₂, where the difference between λ₁ and λ₂ is as described above (e.g., 10-200 nm).

Moreover, in some such embodiments, each build material independently has a Dₚ within a specific range, and each build material independently has an E_{c} within a specific range. For example, in some embodiments, the first Dₚ is between 2 and 7 mils; the second Dₚ is between 4 and 10 mils; the first E_{c} is between 2 and 10 mJ/cm²; and the second E_{c} is between 4 and 15 mJ/cm². It is to be understood that the same principle can apply using other ranges or combinations of Dₚ and E_{c}, such as stated above.

Turning again to the intersection of working curves, in some preferred embodiments, the individual working curves of a plurality of build materials described herein (e.g., the working curve of a first build material and the working curve of a second build material) can intersect within a certain range or window, when plotted on the same axes (e.g., as shown in FIG. 1 or FIG. 2). In some cases, for example, the working curves intersect at a point that is within a specific range of cure depths and within a specific range of exposures. In some such implementations, the working curves intersect at a point having an x-value (exposure) of 3 to 40 mJ/cm² or 3 to 30 mJ/cm², and a y-value (cure depth) of 0 to 50 mils, 10 to 50 mils, 10 to 40 mils, or 10 to 30 mils. The intersection of working curves within such a window can be particularly beneficial, in some cases, for providing a kit and/or carrying out a method in a manner described herein.

The following portions of the present disclosure refer to build materials having certain characteristics at the same wavelength λ. However, it is to be understood that it is possible, in some implementations, to use more than one λ in the same print job or method described herein, or to select (e.g., for a kit) a plurality of differing build materials having a plurality of differing characteristics (such as Dₚ and E_{c} values such as described herein) at a plurality of differing wavelengths, (e.g., λ₁, λ₂, λ₃, . . . λₙ). In some such cases, however, the range of wavelengths λ is relatively small, such as 10-30 nm or 10-50 nm. In other instances, the range of wavelengths λ is relatively large, such as greater than 100 nm, or 100-200 nm. The use of differing wavelengths λ can, in some embodiments, provide additional advantages, such as permitting the use of differing sources of curing radiation while not modifying or changing other print parameters when switching between one build material and another build material as described herein.

It is further to be understood that amounts of photoinitiator(s), non-curable absorber material(s), and/or other components included in a build material (as described further below) can be selected to obtain a desired Dₚ and/or E_{c} value. However, it is to be understood that, in some instances, other components of an ink or build material, such as oligomeric and monomeric curable materials, can vary in type and/or in quantity without substantially changing the desired Dₚ and/or E_{c} values obtained by a particular combination of photoinitiator and/or non-curable absorber material. For instance, in some cases, changes in the type and/or quantity of oligomeric and monomeric curable materials affect the Dₚ and/or E_{c} values of a build material by 5% or less, 4% or less, 3% or less, 2% or less, or 1% or less. More particularly, such minimal changes in the Dₚ and/or E_{c} values can be obtained when components of a build material other than the photoinitiator and non-curable absorber material (such as the oligomeric curable material and/or monomeric curable material) do not absorb (or refract or reflect), or only minimally absorb (or refract or reflect), light of the wavelength λ. Alternatively, such minimal changes in the Dₚ and/or E_{c} values can also be obtained when components of a build material other than the photoinitiator and non-curable absorber material (such as the oligomeric curable material and/or monomeric curable material) absorb (or refract or reflect) light of the wavelength λ to approximately the same degree, no matter which precise species or amounts of components are selected (within the confines of the presently disclosed options for species and amounts). In other words, in the context of the kits, compositions, methods and systems described herein, the components of photocurable build materials described herein, other than the photoinitiator and the non-curable absorber material, can essentially be (and generally are) optical “spectator” species at the wavelength λ, such that these “spectator” species do not substantially affect the Dₚ and/or E_{c} values of the overall material. Thus, the oligomeric and monomeric curable materials can, in some instances, be varied as desired from build material to build material (in terms of precise species and/or quantity) such that the precise species and/or quantity used from build material to build material have similar optical absorption profiles and/or refractive indices.

In some embodiments, the first and/or second build material(s) can comprise a variety of chemical species. Chemical species to include in a build material can be selected according to various considerations including, but not limited to, desired physical, chemical, optical, and/or mechanical properties of the printed article, and/or operating parameters of the 3D printing apparatus.

In some embodiments, the first build material is a first polymerizable liquid. In some embodiments, the second build material is a second polymerizable liquid that differs from the first polymerizable liquid. Any polymerizable liquid not inconsistent with the objectives of this disclosure may be employed as the first and/or second polymerizable liquid.

In some embodiments, the first build material and/or the second build material comprises an oligomeric curable material. The oligomeric curable material of the first build material and the oligomeric curable material of the second build material can be the same or different. An oligomeric curable material can be present in the first build material and/or second build material described herein in any amount not inconsistent with the objectives of the present disclosure. For instance, in some embodiments, the first build material and/or second build material comprises up to 80 wt. % oligomeric curable material, based on the total weight of the first build material and/or based on the total weight of the second build material, respectively. In some embodiments, the first build material and/or the second build material comprises up to 75%, up to 70%, up to 65%, up to 60%, up to 55%, or up to 50% oligomeric curable material, based on the total weight of the first build material and/or based on the total weight of the second build material, respectively. In some embodiments, the first build material and/or the second build material comprises 5-80 wt. %, 5-75 wt. %, 5-70 wt. %, 5-65 wt. %, 5-60 wt. %, 5-55 wt. %, 5-50 wt. %, 5-45 wt. %, 5-40 wt. %, 5-35 wt. %, 5-30 wt. %, 5-25 wt. %, 5-20 wt. %, 5-15 et. %, 10-80 wt. %, 10-75 wt. %, 10-70 wt. %, 10-65 wt. %, 10-60 wt. %, 10-55 wt. %, 10-50 wt. %, 10-45 wt. %, 10-40 wt. %, 10-35 wt. %, 10-30 wt. %, 10-25 wt. %, 10-20 wt. %, 10-15 wt. %, 15-80 wt. %, 15-75 wt. %, 15-70 wt. %, 15-65 wt. %, 15-60 wt. %, 15-55 wt. %, 15-50 wt. %, 15-45 wt. %, 15-40 wt. %, 15-35 wt. %, 15-30 wt. %, 15-25 wt. %, 15-20 wt. %, 20-80 wt. %, 20-75 wt. %, 20-70 wt. %, 20-65 wt. %, 20-60 wt. %, 20-55 wt. %, 20-50 wt. %, 20-45 wt. %, 20-40 wt. %, 20-35 wt. %, 20-30 wt. %, 20-25 wt. %, 25-80 wt. %, 25-75 wt. %, 25-70 wt. %, 25-65 wt. %, 25-60 wt. %, 25-55 wt. %, 25-50 wt. %, 25-45 wt. %, 25-40 wt. %, 25-35 wt. %, or 25-30 wt. % oligomeric curable material, based on the total weight of the first build material and/or based on the total weight of the second build material. It is of course further to be understood that the total weight of each build material is 100 wt. %.

In some embodiments, the first build material and/or the second build material comprises a monomeric curable material. The monomeric curable material of the first build material and the monomeric curable material of the second build material can be the same or different. A monomeric curable material can be present in the first build material and/or second build material described herein in any amount not inconsistent with the objectives of the present disclosure. For instance, in some embodiments, the first build material and/or the second build material comprises up to 80 wt. % monomeric curable material, based on the total weight of the first build material and/or based on the total weight of the second build material, respectively. In some embodiments, the first build material and/or the second build material comprises up to 75%, up to 70%, up to 65%, up to 60%, up to 55%, or up to 50% monomeric curable material, based on the total weight of the first build material and/or based on the total weight of the second build material, respectively. In some embodiments, the first build material and/or the second build material comprises 5-80 wt. %, 5-75 wt. %, 5-70 wt. %, 5-65 wt. %, 5-60 wt. %, 5-55 wt. %, 5-50 wt. %, 5-45 wt. %, 5-40 wt. %, 5-35 wt. %, 5-30 wt. %, 5-25 wt. %, 5-20 wt. %, 5-15 et. %, 10-80 wt. %, 10-75 wt. %, 10-70 wt. %, 10-65 wt. %, 10-60 wt. %, 10-55 wt. %, 10-50 wt. %, 10-45 wt. %, 10-40 wt. %, 10-35 wt. %, 10-30 wt. %, 10-25 wt. %, 10-20 wt. %, 10-15 wt. %, 15-80 wt. %, 15-75 wt. %, 15-70 wt. %, 15-65 wt. %, 15-60 wt. %, 15-55 wt. %, 15-50 wt. %, 15-45 wt. %, 15-40 wt. %, 15-35 wt. %, 15-30 wt. %, 15-25 wt. %, 15-20 wt. %, 20-80 wt. %, 20-75 wt. %, 20-70 wt. %, 20-65 wt. %, 20-60 wt. %, 20-55 wt. %, 20-50 wt. %, 20-45 wt. %, 20-40 wt. %, 20-35 wt. %, 20-30 wt. %, 20-25 wt. %, 25-80 wt. %, 25-75 wt. %, 25-70 wt. %, 25-65 wt. %, 25-60 wt. %, 25-55 wt. %, 25-50 wt. %, 25-45 wt. %, 25-40 wt. %, 25-35 wt. %, or 25-30 wt. % monomeric curable material, based on the total weight of the first build material and/or based on the total weight of the second build material.

A curable material, for reference purposes herein, comprises a chemical species that includes one or more curable or polymerizable moieties. A “polymerizable moiety,” for reference purposes herein, comprises a moiety that can be polymerized or cured to provide a printed 3D article or object. Such polymerizing or curing can be carried out in any manner not inconsistent with the objectives of the present disclosure. In some embodiments, for example, polymerizing or curing comprises irradiating a polymerizable or curable material with electromagnetic radiation having sufficient energy to initiate a polymerization or cross-linking reaction. For instance, in some cases, ultraviolet (UV) radiation can be used. Thus, in some instances, a polymerizable moiety comprises a photo-polymerizable or photo-curable moiety, such as a UV-polymerizable moiety. In some embodiments, a curable material described herein is photo-polymerizable or photo-curable at wavelengths ranging from about 300 nm to about 400 nm or from about 320 nm to about 380 nm. Alternatively, in other instances, a curable material is photo-polymerizable at visible wavelengths of the electromagnetic spectrum.

Moreover, a polymerization reaction, in some cases, comprises a free radical polymerization reaction, such as that between points of unsaturation, including points of ethyleneic unsaturation. Other polymerization reactions may also be used. As understood by one of ordinary skill in the art, a polymerization reaction employed to polymerize a curable material described herein can comprise a reaction of a plurality of “monomers” or chemical species having one or more functional groups or moieties that can react with one another to form one or more covalent bonds.

One non-limiting example of a polymerizable moiety of a curable material described herein is an ethylenically unsaturated moiety, such as a vinyl moiety, allyl moiety, or (meth)acrylate moiety, where the term “(meth)acrylate” throughout this disclosure includes acrylate or methacrylate or a mixture or combination thereof.

Additionally, an oligomeric curable material and/or a monomeric curable material described herein can comprise a monofunctional, difunctional, trifunctional, tetrafunctional, pentafunctional, or higher functional curable species. A “monofunctional” curable species, for reference purposes herein, comprises a chemical species that includes one curable or polymerizable moiety. Similarly, a “difunctional” curable species comprises a chemical species that includes two curable or polymerizable moieties; a “trifunctional” curable species comprises a chemical species that includes three curable or polymerizable moieties; a “tetrafunctional” curable species comprises a chemical species that includes four curable or polymerizable moieties; and a “pentafunctional” curable species comprises a chemical species that includes five curable or polymerizable moieties. Thus, in some embodiments, a monofunctional curable material of a polymerizable liquid described herein comprises a mono(meth)acrylate, a difunctional curable material of a polymerizable liquid described herein comprises a di(meth)acrylate, a trifunctional curable material of a polymerizable liquid described herein comprises a tri(meth)acrylate, a tetrafunctional curable material of a polymerizable liquid described herein comprises a tetra(meth)acrylate, and a pentafunctional curable material of a polymerizable liquid described herein comprises a penta(meth)acrylate. Other monofunctional, difunctional, trifunctional, tetrafunctional, and pentafunctional curable materials may also be used.

Moreover, a monofunctional, difunctional, trifunctional, tetrafunctional, and pentafunctional curable material, in some cases, can comprise a relatively low molecular weight species, i.e., a monomeric species (such as a species having a molecular weight below 300, below 200, or below 100), or a relatively high molecular weight species, i.e., an oligomeric species (such as a species having a molecular weight (e.g., a weight average molecular weight in the case of a species having a molecular weight distribution) above 300, above 400, above 500, or above 600, and optionally below 10,000).

In general, any oligomeric curable material or combination of oligomeric curable materials not inconsistent with the objectives of the present disclosure may be used in a first and/or second build material described herein. In some cases, an oligomeric curable material comprises a polyester acrylate oligomer, polyester (meth)acrylate oligomer, a urethane acrylate oligomer, a urethane (meth)acrylate oligomer, polyether urethane oligomer, or an epoxy(meth)acrylate oligomer. Further, in some embodiments, an oligomeric curable material described herein comprises an aliphatic polyester urethane acrylate oligomer and/or an acrylate amine oligomeric resin, such as EBECRYL 7100.

Some non-limiting examples of commercially available oligomeric curable materials useful in some embodiments described herein include the following: alkoxylated tetrahydrofurfuryl acrylate, commercially available from SARTOMER under the trade name SR 611; monofunctional urethane acrylate, commercially available from RAHN USA under the trade name GENOMER 1122; an aliphatic urethane diacrylate, commercially available from ALLNEX under the trade name EBECRYL 8402; a multifunctional acrylate oligomer, commercially available from DYMAX Corporation under the trade name BR-952; aliphatic polyether urethane acrylate, commercially available from DYMAX Corporation under the trade name BR-371S, and polyether urethane methacrylate, commercially available from DYMAX Corporation under the trade name BR-541 MD. Other commercially available oligomeric curable materials may also be used.

Urethane (meth)acrylates suitable for use in build materials described herein, in some cases, can be prepared in a known manner, typically by reacting a hydroxyl-terminated urethane with acrylic acid or methacrylic acid to give the corresponding urethane (meth)acrylate, or by reacting an isocyanate-terminated prepolymer with hydroxyalkyl acrylates or methacrylates to give the urethane (meth)acrylate. Suitable processes are disclosed, inter alia, in EP-A 114 982 and EP-A 133 908. The weight average molecular weight of such (meth)acrylate oligomers, in some cases, can be from about 500 to 6,000. Urethane (meth)acrylates are also commercially available from SARTOMER under the product names CN980, CN981, CN975 and CN2901. In some embodiments, urethane acrylate oligomers are employed in polymerizable liquids described herein. Suitable urethane acrylates can include difunctional aliphatic urethane acrylates from DYMAX Corporation under the trade designations BR-741 and BR-970. In some embodiments, an oligomeric curable material comprises aliphatic polyester urethane acrylate or aliphatic polyeyther urethane acrylate. Commercial examples of these oligomeric species are available from DYMAX Corporation under the trade designations BR-7432 and BR-543, respectively.

In general, any monomeric curable material or combination of monomeric curable materials not inconsistent with the objectives of the present disclosure may be used in a first and/or second build material described herein. In some cases, a monomeric curable material of a build material described herein comprises one or more species of (meth)acrylates, such as one or more monofunctional, difunctional, trifunctional, tetrafunctional and/or pentafunctional (meth)acrylates. In some embodiments, for instance, a monomeric curable material comprises methyl (meth)acrylate, ethyl (meth)acrylate, n-propyl (meth)acrylate, n-butyl (meth)acrylate, isobutyl (meth)acrylate, n-hexyl (meth)acrylate, 2-ethylhexyl (meth)acrylate, n-octyl (meth)acrylate, n-decyl (meth)acrylate, n-dodecyl (meth)acrylate, 2-hydroxyethyl (meth)acrylate, 2- or 3-hydroxypropyl (meth)acrylate, 2-methoxyethyl (meth)acrylate, 2-ethoxyethyl (meth)acrylate, 2- or 3-ethoxypropyl (meth)acrylate, tetrahydrofurfuryl methacrylate, isobornyl (meth)acrylate, dicyclopentanyl methacrylate, 2-(2-ethoxyethoxy)ethyl acrylate, cyclohexyl methacrylate, 2-phenoxyethyl acrylate, glycidyl acrylate, isodecyl acrylate, 2-phenoxyethyl (meth)acrylate, lauryl methacrylate, or a combination thereof. In some embodiments, a monomeric curable material comprises one or more of allyl acrylate, allyl methacrylate, triethylene glycol di(meth)acrylate, tricyclodecane dimethanol diacrylate, and cyclohexane dimethanol diacrylate. Additionally, in some cases, a monomeric curable material comprises diacrylate and/or dimethacrylate esters of aliphatic, cycloaliphatic or aromatic diols, including 1,3- or 1,4-butanediol, neopentyl glycol, 1,6-hexanediol, diethylene glycol, triethylene glycol, tetraethylene glycol, tripropylene glycol, 1,4-dihydroxymethylcyclohexane, 2,2-bis(4-hydroxycyclohexyl)propane or bis(4-hydroxycyclohexyl)methane, hydroquinone, 4,4′-dihydroxybiphenyl, bisphenol A, bisphenol F, or bisphenol S. A monomeric curable material described herein may also comprise 1,1-trimethylolpropane tri(meth)acrylate, pentaerythritol monohydroxy tri(meth)acrylate, dipentaerythritol monohydroxy penta(meth)acrylate, bis(trimethylolpropane) tetra(meth)acrylate, and/or acryloyl morpholine.

Non-limiting examples of commercially available monomeric curable materials useful in some embodiments described herein include the following: isobornyl acrylate (IBOA), commercially available from SARTOMER under the trade name SR 506; isobornyl methacrylate, commercially available from SARTOMER under the trade name SR 423A; monofunctional acrylate monomer commercially available from SARTOMER under the trade name SR 420; cyclic trimethylolpropane formal acrylate monomer commercially available from SARTOMER under the trade name SR 531; triethylene glycol diacrylate, commercially available from SARTOMER under the trade name SR 272; triethylene glycol dimethacrylate, commercially available from SARTOMER under the trade name SR 205; tricyclodecane dimethanol diacrylate, commercially available from SARTOMER under the trade name SR 833S; tris(2-hydroxy ethyl)isocyanurate triacrylate, commercially available from SARTOMER under the trade name SR 368; 2-phenoxyethyl acrylate, commercially available from SARTOMER under the trade name SR 339; ethyoxylated (3 mole) bisphenol A diacrylate, commercially available from SARTOMER under the trade name SR 349; a cyclic monofunctional acrylate, commercially available by RAHN USA Corp. under the trade name GENOMER 1120; dipentaerythritol pentaacrylate, commercially available from SARTOMER under the trade name SR 399 LV; and dicyclopentanyl acrylate and/or dicyclopentanyl methacrylate, commercially available from Showa Denko Materials under the trade name FA-513 M. Other commercially available monomeric curable materials may also be used.

In some embodiments, the isocyanurate polyacrylate is of the formula:

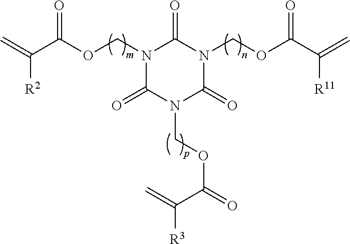

wherein R¹-R³ are each independently selected from the group consisting of hydrogen and alkyl (e.g., C1-C10 alkyl) and m, n, and p are integers independently ranging from 1 to 10.

In some embodiments, the monomeric curable material comprises a heterocycle comprising two or more unsaturated substituents. The substituted heterocycle, for example, can comprise three unsaturated substituents. The heterocycle can be polyallylated, in some embodiments. In being polyallylated, the heterocycle comprises two of more allyl substituents. For example, a polyallylated heterocycle can comprise a polyallyl isocyanurate. Alternatively, a heterocycle comprising two or more unsaturated substituents can be of the formula:

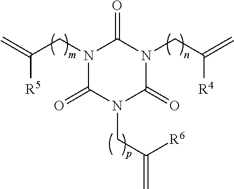

wherein R⁴-R⁶ are each independently selected from the group consisting of hydrogen and alkyl (e.g., C1-C10 alkyl) and m, n, and p are integers independently ranging from 1 to 10.

In some embodiments, the monomeric curable material comprises cyclocarbonate (meth)acrylate monomer. For example, the monomeric curable material can comprise cyclocarbonate (meth)acrylate monomer of the formula:

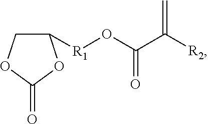

wherein R₁ is a linear or branched C₁-C₆ alkylene moiety; and wherein R₂ is H or CH₃.

The monomeric curable material can comprise one species of monomer or a mixture of any species of monomer described above.

Additionally, the first and/or second build material, in some embodiments, comprises polymeric particles dispersed in a curable carrier. The polymeric particles can be of any composition and/or architecture not inconsistent with achieving the technical objectives described herein. The polymeric particles can comprise or be formed from an elastomer, thermoplastic, thermoset, or any combination thereof. Specific compositional identity of the polymeric particles can be selected according to the desired mechanical properties of the printed article. In some embodiments, the polymeric particles exhibit a core-shell architecture. The polymeric particles, for example, can comprise an elastomeric core and thermoplastic or thermoset shell. In some embodiments, composite resins comprising core-shell particles in a curable resin are commercially available from Kaneka Texas Corporation under the Kane Ace® MX trade designation. The polymeric particles may have any desired size. In some embodiments, the polymeric particles have a size less than 1 μm. The polymeric particles, for example, may have an average size of 50 nm to 500 nm. In other embodiments, the polymeric particles can have an average size greater than 1 μm, such as 5 μm to 50 μm.

The polymeric particles can be present in the curable carrier in any desired amount. In some embodiments, the polymeric particles are present in an amount of 20-70 wt. % or 30-60 wt. % based on total weight of the composite resin. Moreover, the composite resin can be present in the first and/or second build material in any amount not inconsistent with the technical objectives described herein. The composite resin, for example, can be present in an amount of at least 20 wt. % or at least 30 wt. % based on total weight of the first and/or second build material. In some embodiments, the composite resin is present in an amount of 5-30 wt. % based on total weight of the build material containing the same.

A first and/or second build material described herein can further comprise a photoinitiator component for initiating polymerization of one or more components thereof upon exposure to light of the proper wavelength. The photoinitiator of the first build material and the photoinitiator of the second build material can be the same or different. In some embodiments, the photoinitiator component can initiate polymerization of a component described herein comprising one or more points of unsaturation polymerizable via free radical mechanisms. Similarly, a photoinitiator can be employed to polymerize a (meth)acrylate component. In some embodiments, a non-(meth)acrylate component component described herein can be copolymerized with a (meth)acrylate component. In other embodiments, a non-(meth)acrylate component and a (meth)acrylate component are polymerized independently.

A photoinitiator can be present in the first build material and/or second build material described herein in any amount not inconsistent with the objectives of the present disclosure. For instance, in some embodiments, the first build material and/or the second build material comprises up to 10 wt. % photoinitiator, based on the total weight of the first build material and/or based on the total weight of the second build material, respectively. In some embodiments, the first build material and/or the second build material comprises up to 9 wt. %, up to 8 wt. %, up to 7 wt. %, up to 6 wt. %, up to 5 wt. %, up to 4 wt. %, or up to 3 wt. %, photoinitiator, based on the total weight of the first build material and/or based on the total weight of the second build material, respectively. In some embodiments, the first build material and/or the second build material comprises 0.1-10 wt. %, 0.1-5 wt. %, 1-10 wt. %, or 1-5 wt. % photoinitiator, based on the total weight of the first build material and/or based on the total weight of the second build material, respectively.

Any photoinitiator not inconsistent with the objectives of the present disclosure can be used. In some embodiments, a photoinitiator comprises an alpha-cleavage type (unimolecular decomposition process) photoinitiator or a hydrogen abstraction photosensitizer-tertiary amine synergist, operable to absorb light preferably between about 250 nm and about 420 nm, or between about 300 nm and about 385 nm, to yield free radical(s).

Examples of alpha cleavage photoinitiators are Irgacure 184 (CAS 947-19-3), Irgacure 369 (CAS 119313-12-1), and Irgacure 819 (CAS 162881-26-7). An example of a photosensitizer-amine combination is Darocur BP (CAS 119-61-9) with diethylaminoethylmethacrylate.

In addition, in some instances, suitable photoinitiators comprise benzoins, including benzoin, benzoin ethers, such as benzoin methyl ether, benzoin ethyl ether and benzoin isopropyl ether, benzoin phenyl ether and benzoin acetate, acetophenones, including acetophenone, 2,2-dimethoxyacetophenone and 1,1-dichloroacetophenone, benzil, benzil ketals, such as benzil dimethyl ketal and benzil diethyl ketal, anthraquinones, including 2-methylanthraquinone, 2-ethylanthraquinone, 2-tert-butylanthraquinone, 1-chloroanthraquinone and 2-amylanthraquinone, triphenylphosphine, benzoylphosphine oxides, for example 2,4,6-trimethylbenzoyldiphenylphosphine oxide (Lucirin TPO), benzophenones, such as benzophenone and 4,4′-bis(N,N′-dimethylamino)benzophenone, thioxanthones and xanthones, acridine derivatives, phenazine derivatives, quinoxaline derivatives or 1-phenyl-1,2-propanedione, 2-O-benzoyl oxime, 1-aminophenyl ketones or 1-hydroxyphenyl ketones, such as 1-hydroxycyclohexyl phenyl ketone, phenyl 1-hydroxyisopropyl ketone and 4-isopropylphenyl 1-hydroxyisopropyl ketone.

Suitable photoinitiators can also comprise those operable for use with a HeCd laser radiation source, including acetophenones, 2,2-dialkoxybenzophenones and 1-hydroxyphenyl ketones, such as 1-hydroxycyclohexyl phenyl ketone or 2-hydroxyisopropyl phenyl ketone (=2-hydroxy-2,2-dimethylacetophenone). Additionally, in some cases, suitable photoinitiators comprise those operable for use with an Ar laser radiation source including benzil ketals, such as benzil dimethyl ketal. In some embodiments, a photoinitiator comprises an α-hydroxyphenyl ketone, benzil dimethyl ketal or 2,4,6-trimethylbenzoyldiphenylphosphine oxide or a mixture thereof.

Another class of suitable photoinitiators, in some instances, comprises ionic dye-counter ion compounds capable of absorbing actinic radiation and generating free radicals for polymerization initiation. In some embodiments, polymerizable liquids containing ionic dye-counter ion compounds can be polymerized upon exposure to visible light within the adjustable wavelength range of about 400 nm to about 700 nm. Ionic dye-counter ion compounds and their mode of operation are disclosed in EP-A-0 223 587 and U.S. Pat. Nos. 4,751,102; 4,772,530; and 4,772,541.

In some embodiments, the first build material and/or the second build material comprises one or more additional components, in addition to the oligomeric curable material, monomeric curable material, optional polymeric particles, and/or photoinitiator described hereinabove. The one or more additional components of the first build material and the one or more additional components of the second build material can be the same or different. The one or more additional components may be present in the first build material and/or second build material in any amount not inconsistent with the objectives of the present disclosure. For instance, in some embodiments, the first build material and/or second build material comprises up to 40 wt. % of one or more additional components, based on the total weight of the first build material and/or based on the total weight of the second build material, respectively. in some embodiments, the first build material and/or second build material comprises up to 35 wt. %, up to 30 wt. %, or up to 25 wt. % of one or more additional components, based on the total weight of the first build material and/or based on the total weight of the second build material, respectively.

For instance, in one aspect, the first build material and/or second build material comprises one or more additives. In some embodiments, an additive includes a plurality of cyclopolymerizable functionalities separated by an aliphatic linker or alkylene oxide linker, the cyclopolymerizable functionalities of the formula:

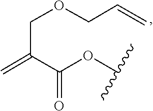 [SMILES: *OC(=O)C(=C)COCC=C]

where [symbol] is an attachment point of the cyclopolymerizable functionality to the linker. In some embodiments, the additive is of the formula:

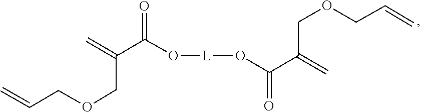

wherein L is the aliphatic or alkylene oxide linker. When present, the alkylene oxide linker can be oligomeric or polymeric. In such embodiments, the additive can be of the formula:

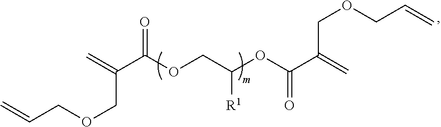

wherein R¹ is hydrogen or alkyl (e.g., C1-C10 alkyl, where a “Cn” alkyl is understood to include exactly “n” carbon atoms), and m is an integer from 1 to 20. In some embodiments, the additive comprises three or more cyclopolymerizable functionalities.

An additive such as described above can be present in the first and/or second build material in any amount not inconsistent with the technical objective of improving or enhancing mechanical properties of three-dimensional articles printed from the first and second build materials. In some embodiments, the amount of additive is selected according to various considerations including, but not limited to, desired set of mechanical properties of an article printed from the build material, printing conditions, and/or chemical identity of other species in the build material. In some embodiments, one or more additives are present in a first and/or second build material in a total amount of 5 to 40 wt. %, 5 to 30 wt. %, 7 to 30 wt. %, 10 to 30 wt. %, or 10 to 20 wt. %, based on total weight of the first and/or second build material, respectively.

Moreover, in some embodiments, a first and/or second build material described herein can further comprise one or more sensitizers. A sensitizer can be added to increase the effectiveness of one or more photoinitiators that may also be present. Any sensitizer not inconsistent with the objectives of the present disclosure may be used. In some cases, a sensitizer comprises isopropylthioxanthone (ITX) or 2-chlorothioxanthone (CTX). A sensitizer can be present in the first and/or second build material in any amount not inconsistent with the objectives of the present disclosure. In some embodiments, a sensitizer is present in an amount ranging from about 0.1 wt. % to about 2 wt. % or from about 0.5 wt. % to about 1 wt. %, based on the total weight of the first and/or second build material, respectively.

In some embodiments, one or more UV-absorbers and/or light stabilizers can be present in the first and/or second build materials. In some embodiments, for example, one or more UV-absorbers and/or light stabilizers can be present in the first and/or second build material in an amount of 0.1-2 wt. %, based on the total weight of the first and/or second build material, respectively. In some embodiments, UV-absorbers and/or light stabilizers are commercially available from BASF of Florham Park, New Jersey under the TINUVIN® trade-designation.

In some embodiments, a first and/or second build material may comprise a silica component. In some embodiments, the silica component is colloidal silica or fumed silica. Colloidal silica, in some cases, can comprise nanoparticles of silica dispersed or suspended in a fluid material. The nanoparticles of silica, in some embodiments, have an average particle size of about 100 nm or less, about 50 nm or less, or about 20 nm or less. In addition, the colloidal silica of a first and/or second build material described herein can be suspended or dispersed in another component of the first and/or second build material. For example, in some embodiments, the colloidal silica is dispersed or suspended in a (meth)acrylate monomer. Such a suspension or dispersion of nanoparticles of silica in (meth)acrylate monomer may be obtained commercially. In some cases, for instance, a first and/or second build material described herein comprises a NANOCRYL material, available from Evonik Industries.

A first and/or second build material described herein may also optionally contain other materials in suitable amounts, as long as the objectives of the present disclosure are not affected. Examples of such materials include radical-polymerizable organic substances, coloring agents such as pigments and dyes, antifoaming agents, leveling agents, thickening agents, flame retardants and/or antioxidants.

Moreover, in some embodiments, a second build material described herein comprises at least one supplemental component that is not present in the first build material. It should be understood that a “supplemental” component as described herein is or can be a component that is present in the second build material that is not present in the first build material. The “supplemental” component can be an additional component that is present in the second build material but not the first material (i.e., a component that is present in the second build material in addition to all the components present in the first build material), or can also be a component in the second build material that replaces one or more components of the first build material or base material (i.e., a component that is present in the second build material substituting one or more components present in the first material). In some embodiments, the first build material and the second build material have identical chemical compositions except for the supplemental component of the second build material.

In some embodiments, the supplemental component is present in the second build material in an amount of up to 30 wt. %, based on the total weight of the second build material. In some embodiments, the supplemental component is present in the second build material in an amount of up to 25 wt. %, up to 20 wt. %, up to 15 wt. %, up to 10 wt. %, or up to 5 wt. %, based on the total weight of the second build material. In some embodiments, the supplemental component is present in the second build material in an amount of 1-30 wt. %, 5-30 wt. %, 10-30 wt. %, 15-30 wt. %, 20-30 wt. %, 25-30 wt. %, 1-25 wt. %, 5-25 wt. %, 10-25 wt. %, 15-25 wt. %, 20-25 wt. %, 1-20 wt. %, 5-20 wt. %, 10-20 wt. %, 15-20 wt. %, 1-15 wt. %, 5-15 wt. %, 10-15 wt. %, 1-10 wt. %, 5-10 wt. %, or 1-5 wt. %, based on the total weight of the second build material.

In some embodiments, one or both of the first build material and/or the second material comprises up to 80 wt. % oligomeric curable material, up to 80 wt. % monomeric curable material, up to 10 wt. % photoinitiator, and up to 40 wt. % one or more additional components, based on the total weight of the first build material and/or based on the total weight of the second build material, respectively.

In some embodiments, the first build material and the second build material each comprise, based on the respective total weight of each build material, up to 80 wt. % oligomeric curable material, up to 80 wt. % monomeric curable material, up to 10 wt. % photoinitiator, and up to 40 wt. % one or more additional components. In some embodiments, the second build material additionally comprises up to 30 wt. % of one or more supplemental component(s) not present in the first build material.

As described hereinabove, the oligomeric curable material, monomeric curable material, photoinitiator, and/or additional component(s) of the first build material and the oligomeric curable material, monomeric curable material, photoinitiator, and/or additional component(s) of the second build material can be the same or different. For instance, in some embodiments, the oligomeric curable material and monomeric curable material of the first build material are the same as the oligomeric curable material and monomeric curable material of the second build material. In some embodiments, the oligomeric curable material of the first build material is the same as the oligomeric curable material of the second build material, but the monomeric curable material of the first build material is different from the monomeric curable material of the second build material. In other embodiments, the monomeric curable material of the first build material is the same as the monomeric curable material of the second build material, but the oligomeric curable material of the first build material is different from the oligomeric curable material of the second build material. In some embodiments, the oligomeric curable material and the monomeric curable material of the first build material are the same as the oligomeric curable material and the monomeric curable material of the second build material, but the photoinitiator of the first build material is different from the photoinitiator of the second build material. In some embodiments, the oligomeric curable material and the monomeric curable material of the first build material are different from the oligomeric curable material and the monomeric curable material of the second build material, and the photoinitiator of the first build material is also different from the photoinitiator of the second build material. In some embodiments, the oligomeric curable material and the monomeric curable material of the first build material are the same as the oligomeric curable material and the monomeric curable material of the second build material, but the one or more additional components of the first build material are different from the one or more additional components of the second build material. In some embodiments, the oligomeric curable material and the monomeric curable material of the first build material are different from the oligomeric curable material and the monomeric curable material of the second build material, and the one or more additional components of the first build material are also different from the one or more additional components of the second build material. In some embodiments, the oligomeric curable material, monomeric curable material, photoinitiator, and additional component(s) of the first build material are all the same as the oligomeric curable material, monomeric curable material, photoinitiator, and additional component(s) of the second build material. In other embodiments, the oligomeric curable material, monomeric curable material, photoinitiator, and additional component(s) of the first build material are all different from the oligomeric curable material, monomeric curable material, photoinitiator, and additional component(s) of the second build material. Any combination of similar and/or different oligomeric curable materials, monomeric curable materials, photoinitiators, and additional components may be employed for the first and second build materials described herein.

In some embodiments, when consolidated into layers of a printed part, the first and second build materials can form regions that, upon completion of the printed part, have at least one property that differs by at least 20%, at least 25%, at least 30%, at least 35%, at least 40%, at least 45%, or at least 50%.

For instance, in some embodiments, a first build material is a polymerizable liquid, and a second build material is a second polymerizable liquid, and the first polymerizable liquid, when cured, and the second polymerizable liquid, when cured, have at least one property that differs by at least 20%, at least 25%, at least 30%, at least 35%, at least 40%, at least 45%, or at least 50%. In some embodiments, the first polymerizable liquid, when cured, and the second polymerizable liquid, when cured, have at least one property that differs by 20-100%, 25-100%, 30-100%, 35-100%, 40-100%, 45-100%, 50-100%, 75-100%, 20-99%, 25-99%, 30-99%, 35-99%, 40-99%, 45-99%, 50-99%, 75-99%, 20-95%, 25-95%, 30-95%, 35-95%, 40-95%, 45-95%, 50-95%, 75-95%, 20-90%, 25-90%, 30-90%, 35-90%, 40-90%, 45-90%, 50-90%, 75-90%, 20-85%, 25-85%, 30-85%, 35-85%, 40-85%, 45-85%, 50-85%, 75-85%, 20-80%, 25-80%, 30-80%, 35-80%, 40-80%, 45-80%, 50-80%, 75-80%, 20-75%, 25-75%, 30-75%, 35-75%, 40-75%, 45-75%, or 50-75%. In such cases, the percentage can be based on using as the denominator the larger value of the two values being compared, when both values are reported and measured in the same way (e.g., when both values are reported in MPa and measured in accordance with the same ASTM standard).

It is further to be noted that any relevant or appropriate value or quantification of a property may be used when comparing properties as described herein. For example, a temperature difference may be in degrees Celsius, if desired. Similarly, chemical reactivity can be quantified for purposes of the present disclosure in any manner known to one of ordinary skill in the art. For instance, in some cases, chemical reactivity is quantified based on the Mayr-Patz equation (MPE), the Mayr reactivity scale, or an extension of the foregoing, such as described in Proppe et al., “Uncertainty Quantification of Reactivity Scales,” ChemPhysChem (2022), available at https://doi.org/10.1002/cphc.202200061; based on the activation strain model (ASM) of reactivity, such as described in Vermeeren et al., “Understanding chemical reactivity using the activation strain model, “Nature Protocols, 15, 649-667 (2020); or based on change in potential energy as described in Bac et al., “Transition Structures, Reaction Paths, and Kinetics: Methods and Applications in Catalysis,” Comprehensive Computational Chemistry, vol. 4 (2024), pages 496-518. Other methods may also be used. Likewise, in some cases, a build material's wettability can be based on contact angle analysis. Specific quantification methods are not necessarily limited, provided that for comparison purposes as described herein, a relevant property is quantified and/or measured consistently when compared one build material to another build material.

Any property not inconsistent with the objectives of the present application may differ between the first and second build materials by at least 20%. For example, in some cases, the property is a mechanical property, thermal property, and/or optical property. Some such example properties are described immediately below.

In this context, it is to be understood that articles printed using build materials and/or according to methods described herein (or the cured build materials themselves, or specific regions of a printed article) can exhibit one or more desirable mechanical properties, due to the compositions and microstructures of the printed articles. For example, in some cases, 3D articles (or regions thereof) printed from build materials described herein may display a tensile modulus of 1900-2700 MPa. A 3D printed article (or region thereof), in some embodiments, can exhibit a tensile strength of greater than 40 MPa, such as a tensile strength of 40-70 MPa or 50-65 MPa. Values for tensile strength and tensile modulus provided herein can be determined according to ASTM D638.

Additionally, 3D articles (or regions thereof) printed from build materials described herein can exhibit an elongation at break of at least 3%, at least 5% or at least 10% (e.g., when determined according to ASTM D638). In some embodiments, a printed 3D article (or region thereof) has an elongation at break of greater than 10%, such as an elongation at break of 10-20%, when determined by ASTM D638.

3D articles (or regions thereof) printed from build materials described herein can also exhibit a heat deflection temperature (HDT) of at least 90° C., such as 100-260° C. In some embodiments, a 3D article (or region thereof) printed from build materials described herein can have a HDT greater than 300° C. HDT is measured using DMA at 0.455 MPa according to ASTM D648.

Further, in some cases, 3D articles (or regions thereof) printed from build materials described herein (and the build materials themselves, upon polymerization) can have other desirable compositional parameters or features. For instance, in some implementations, a 3D article (or region thereof) or build material described herein has a relatively high stress-relaxation value or residual stress (e.g., as measured in accordance with ASTM E837 or ASTM D638 Type IV). Moreover, in some embodiments, a 3D article (or region thereof) or build material described herein has a relatively high stress-relaxation/residual stress value in water at 37° C. For instance, in some preferred embodiments, a 3D article (or region thereof) or build material described herein has a stress-relaxation/residual stress value, or a stress relaxation remaining load (5% strain), in water at 37° C. of greater than 1 Newton (N), such as a value of 1-5 N, 1-3 N, 1-2 N, or 1-1.5 N, when measured in accordance with ASTM D638 Type IV.

Moreover, 3D articles (or regions thereof) printed from build materials described herein (and the build materials themselves, upon polymerization) can be resistant to hydrolysis or degradation due to water exposure. For example, in some cases a build material described herein (or a 3D article or region printed therefrom) can have a hydrolysis resistance with respect to maintenance of certain mechanical properties, such as flexural strength, flexural modulus, and/or elongation at break, after exposure to water. Thus, a 3D article (or region thereof) or build material described herein can (due to its composition/microstructure) exhibit one, two, or all three of the following hydrolysis resistance metrics:
Flexural Strength (FS) Hydrolysis Resistance of at least 80%, at least 85%, at least 90%, or at least 95%;
Flexural Modulus (FM) Hydrolysis Resistance of at least 80%, at least 85%, at least 90%, or at least 95%; and
Elongation at Break (EOB) Hydrolysis Resistance of at least 80%, at least 85%, at least 90%, or at least 95%.

The above metrics are based on “water exposure” of a 3D article (or region thereof or build material) as follows. The relevant property (i.e., the flexural strength, flexural modulus, or elongation at break) of a test sample (e.g., the 3D article or excised region formed from the build material) is measured following printing of the 3D article (e.g., within 12 hours). The test sample is then immersed in water at 37° C. for 24 hours. Following this immersion period, the test sample is dried and the relevant property (i.e., the flexural strength, flexural modulus, or elongation at break) is measured again in the same manner as before (e.g., using ASTM D638, and providing an output in MPa). The post-immersion measurement is then compared to the pre-immersion measurement. For example, if a given test sample has a flexural strength of 100 MPa prior to water immersion, and a flexural strength of 95 MPa after water immersion for 24 hours, then the Flexural Strength Hydrolysis Resistance would be 95%, derived from comparing 95 MPa to 100 MPa.

Moreover, in some embodiments, it is even possible for water immersion to improve a specific property, such as the elongation at break. In some cases, for instance, a 3D article (or region thereof) described herein has an EOB Hydrolysis Resistance of 80-130%, 80-125%, 90-125%, or 90-120%. The Flexural Strength Hydrolysis Resistance and/or the Flexural Modulus Hydrolysis Resistance may also, in some cases, be up to 110% or 105%, though it is to be understood that 100% is the typical maximum value.

Additionally, in some preferred embodiments, a 3D article (or region thereof) printed from a build material described herein (and the build material itself, upon polymerization) has one, two, three, four, five, six, seven, eight, nine, ten, or all eleven of the following compositional parameters:
(1) a stress-relaxation/residual stress value (or a stress relaxation remaining load, 5% strain) in water at 37° C. of greater than 1 N (e.g., 1-5 N, 1-3 N, 1-2 N, or 1-1.5 N), when measured in accordance with ASTM D638 Type IV;
(2) a stress relaxation starting load (5% strain) in water at 37° C. of less than 35 N or less than 30 N (e.g., 15-35 N or 20-35 N), when measured in accordance with ASTM D638 Type IV; (3) a tensile strength of greater than 30 MPa or greater than 40 MPa (e.g., 40-70 MPa or 50-65 MPa), when measured in accordance with ISO 527 or ASTM D638 Type IV;
(4) a flexural strength of greater than 35 MPa or greater than 40 MPa (e.g., 35-50 MPa or 40-50 MPa), when measured in accordance with ISO 20795-2;
(5) a flexural modulus of greater than 1000 MPa (e.g., 1000-2000 MPa or 1000-1500 MPa), when measured in accordance with ISO 20795-2;
(6) a Charpy Impact 1J value of greater than 3, greater than 5, greater than 8, or greater than 10 kJ/m³ (e.g., 5-25 kJ/m³, 5-20 kJ/m³, 8-25 kJ/m³, 8-20 kJ/m³, 10-25 kJ/m³, 10-20 kJ/m³, or 15-25 kJ/m³, when measured in accordance with ISO 179;
(7) an elongation at break of greater than 8% or greater than 10% (e.g., 10-20%), when measured in accordance with ISO 527 or ASTM D638 Type IV;
(8) an impact strength of 5 J/m or greater or 15 J/m or greater when measured according to ASTM D256 (e.g., 5-25 J/m, 5-20 5 J/m, 5-15 J/m, or 10-25 J/m);
(9) a Notched Izod impact strength of at least 50 J/m or at least 75 J/m when measured according to ASTM D256 (e.g., 50-150 J/m, 50-125 J/m, 50-100 J/m, 75-150 J/m, 75-125 J/m, or 75-100 J/m);
(10) a Shore A hardness of at least 20 when measured according to ASTM D2240 (e.g., 20-60, 20-50, 20-40, 30-60, or 30-50); and
(11) a HDT value of at least 130° C. as measured using ISO 25-2:2004 (e.g., 100-260° C.).

Build materials described herein can exhibit a variety of desirable properties, such as those described hereinabove, in a cured state. A build material in a “cured” state, as used herein, comprises a build material that includes a curable material or polymerizable component that has been at least partially cured, i.e., at least partially polymerized and/or cross-linked. For instance, in some cases, a cured build material is at least about 70% polymerized or cross-linked or at least about 80% polymerized or cross-linked. In some embodiments, a cured build material is at least about 85%, at least about 90%, at least about 95%, at least about 98%, or at least 99% polymerized or cross-linked. In some instances, a cured build material is between about 80% and about 99% polymerized or cross-linked. In some instances, a cured composition or material is between about 80% and about 99% polymerized or cross-linked. The degree of polymerization or cross-linking can be determined using any protocol or method not inconsistent with the technical objectives of the present disclosure, such as by determining the percentage of monomers incorporated into the polymer network (e.g., based on molecular weight of the polymer compared to the molecular weight of the monomer, or based on the total polymer mass compared to the theoretical maximum of the total polymer mass) or by determining the amount of unincorporated monomers. When more than one method is used to determine a degree of polymerization or cross-linking, the results of the methods can be averaged to obtain a percentage described herein. It is further to be understood that the degree of polymerization or cross-linking described herein is different than “degree of polymerization” defined as the number of repeating units in a polymer molecule

In addition, in some embodiments, one or more properties of a first build material and a second build material described herein remain the same or similar from one build material to another when the build materials are cured and/or consolidated into layers of a printed part, while a different property or properties differ(s) by at least 20% as discussed hereinabove. For instance, in some embodiments, the first build material, when cured, and the second build material, when cured, have at least one property that differs by less than 10%, less than 9%, less than 8%, less than 7%, less than 6%, less than 5%, less than 4%, less than 3%, less than 2%, or less than 1%. Such properties can be selected from among the same properties described immediately above for properties that can differ between differing build materials used in a kit, system, or method described herein.

It is further to be understood that kits, systems, and methods described herein are not limited to only two differing build materials. Instead, any desired number of build materials may be used, consistent with the principles above. For example, in some embodiments, in addition to first and second build materials as described hereinabove, a kit may also include one or more (hereinafter “n”) additional build material(s). In some embodiments, the n additional build material(s) do not have the same chemical composition(s) as the first build material or the second build material. In some embodiments, when more than one n additional material is included in a kit, the n additional build materials have different chemical compositions from one another. In some embodiments, n is an integer ranging from 1 to 100.

It is further to be understood that the n additional build material(s) may be solid or liquid at ambient temperatures. Additionally, it is to be understood that in general the n build material(s) and the first and second build materials have the same mode of consolidation. For instance, in some embodiments, the first, second, and nth build materials are photopolymerizable or photocurable.

Additionally, it is to be understood that the n additional build material(s) can comprise a variety of chemical species as discussed hereinabove with respect to the first and second build materials. For example, in some embodiments, the n additional build material(s) is/are polymerizable liquid(s). Any polymerizable liquid as described hereinabove, and not inconsistent with the objectives of this disclosure, may be employed as the n additional polymerizable liquid(s) in such an instance.

For example, in some embodiments, the n additional build material(s) can each comprise oligomeric curable material(s), monomeric curable material(s), photoinitiator(s), and/or additional component(s) as described above, and in the amounts described hereinabove with respect to the first build material and the second build material. Any oligomeric curable material(s), monomeric curable material(s), photoinitiator(s), and/or additional component(s) described elsewhere in this disclosure may be employed. In some embodiments, the n additional build material(s) can each comprise one or more supplemental component(s) as described hereinabove with respect to the second build material. Any supplemental component described elsewhere in this disclosure may be employed. That is, in some cases, each of the n additional build materials can be considered to be variations of the first build material or variations of a base build material, as described above.

It is further to be understood that such additional build materials (in a photocuring system or otherwise) can have n additional properties, such as described above for first and second build materials. Without intending to exhaustively describe all possible combinations, in some embodiments, for example, the n additional build material(s) have n additional surface tension(s) at the temperature T, n additional wettability value(s) at the temperature T, n additional chemical reactivities at the temperature T, n additional melting point onset temperature(s), n additional total optical absorbance(s) or light penetration depth(s) at a wavelength λ, n additional photocuring working curve(s) at the wavelength λ, n additional Dₚ value(s) at the wavelength λ, and/or n additional E_{c} value(s) at the wavelength λ.

Likewise, in some embodiments, the n additional photocuring working curves (when present) intersect with the first photocuring working curve, the second photocuring working curve, and with each other (e.g., within a range or window described above, such as at a point having an x-value (exposure) of 3 to 40 mJ/cm² or 3 to 30 mJ/cm², and a y-value (cure depth) of 0 to 50 mils, 10 to 50 mils, 10 to 40 mils, or 10 to 30 mils). Further, in some cases, the n additional Dₚ values are each between 2 and 10 mils and the n additional E_{c} values are each between 2 and 15 mJ/cm². Other values and combinations are also possible (as described above). For instance, in some cases, for the n build materials of a kit described herein, the n Dₚ values are each between 2 and 8 mils, between 2 and 10 mils, between 4 and 8 mils, between 4 and 7 mils, or between 5 and 10 mils; and the n E_{c} values are each between 2 and 10 mJ/cm², between 2 and 15 mJ/cm², between 2 and 20 mJ/cm², between 3 and 15 mJ/cm², between 4 and 15 mJ/cm², between 4 and 25 mJ/cm², between 5 and 15 mJ/cm², or between 6 and 15 mJ/cm²; and optionally each of the n Dₚ values differ from one another (or from a reference Dₚ such as a first Dₚ described herein) by 1 mil or less or by no more than 20% or no more than 15%, and each of the n E_{c} values differ from one another (or from a reference E_{c} such as a first E_{c} described herein) by no more than 20% or no more than 15%.

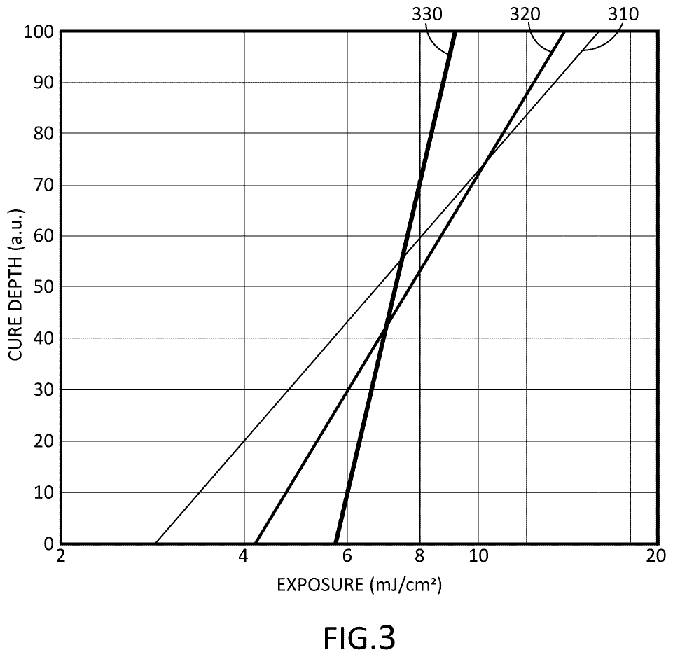

For example, for illustration purposes, FIG. 3 shows three such working curves (though it is to be understood that more than three curves are possible). FIG. 3 is analogous to FIG. 1 and FIG. 2 described above. In FIG. 3, a first working curve (310) is associated with a first build material, a second working curve (320) is associated with a second build material, and a third working curve (330) is associated with a third build material. As illustrated in FIG. 3, the first working curve (310) intersects the second working curve (320) and the third working curve (330). The second working curve (320) and the third working curve (330) also intersect. When the entire plot of FIG. 3 (ranging from 2 to 20 mJ/cm² as the exposure on the x-axis, and ranging from 0 to 100 arbitrary units as the cure depth on the y-axis) is taken to represent a preferred “window” (e.g., a “window” of 2 to 20 mJ/cm² (exposure, x-axis) and 0 to 50 mils (cure depth, y-axis)), then it can be seen that all three working curves (310, 320, 330) intersect with each other within the preferred window. Such a kit or “system” of build materials can provide advantages in some embodiments, as described further herein (e.g., use within a single print job without changing print parameters).

It is also possible for build materials that do not necessarily intersect in such a window to be used advantageously in a kit or method described herein. For example, in some cases, the build materials of a kit described herein each have a Dₚ value that differs by less than 1 mil from the Dₚ value of a first or “reference” or “baseline” build material, or that differs by less than 1 mil from the Dₚ values of every other build material of the kit.

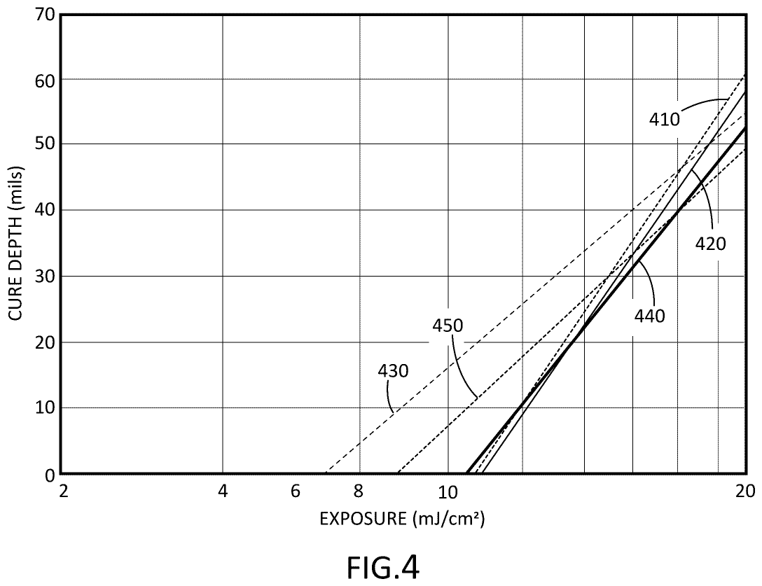

Thus, in some cases, build materials suitable for use in a kit described herein can have working curves that either (1) intersect as noted above (e.g., at a point within a window of 3 to 40 mJ/cm² and 0 to 50 mils), and/or (2) have Dₚ values that differ by 1 mil or less. If either of the foregoing is satisfied for a given set of build materials and their working curves, then the build materials may advantageously be used to provide a kit as described herein, in some embodiments. Additional description regarding such a kit or system is provided in the specific Examples hereinbelow, including with reference to FIG. 4.

Turning again to other possible features of kits comprising n additional build materials, in a similar manner as described above for first and second build materials, in some embodiments, the n additional surface tensions differ from the first surface tension, the second surface tension, and one another by 10% or less, 9% or less, 8% or less, 7% or less, 6% or less, 5% or less, 4% or less, 3% or less, 2% or less, or 1% or less. In other embodiments, the n additional wettability value(s) at the temperature T differ from the first wettability at the temperature T, the second wettability at the temperature T, and one another by 10% or less, 9% or less, 8% or less, 7% or less, 6% or less, 5% or less, 4% or less, 3% or less, 2% or less, or 1% or less. Moreover, in some cases, the n additional chemical reactivity value(s) at the temperature T differ from the first chemical reactivity at the temperature T, the second chemical reactivity at the temperature T, and one another by 10% or less, 9% or less, 8% or less, 7% or less, 6% or less, 5% or less, 4% or less, 3% or less, 2% or less, or 1% or less. Likewise, in some implementations, the n additional melting point onset temperature(s), differ from the first melting point onset temperature, the second melting point onset temperature, and one another by 10% or less, 9% or less, 8% or less, 7% or less, 6% or less, 5% or less, 4% or less, 3% or less, 2% or less, or 1% or less.

A kit described herein, in some embodiments, provides a 3D article comprising or formed from multiple build materials having different properties which can be obtained without changing printing parameters, wherein the article has different areas with different properties.

### II. Methods of Printing and Systems for Printing

In another aspect, a method of printing a three-dimensional article is provided. A method described herein may be applied in a variety of additive manufacturing techniques, such as, for example, photocuring 3D printing (including stereolithography (SLA), digital light processing (DLP), liquid crystal display (LCD), multi-jet printing (MJP), continuous liquid interface production (CLIP), two-photon 3D printing (TPP), holographic 3D printing, and other photopolymerization printing technologies), fused deposition modeling (FDM), selective laser sintering (SLS), selective laser melting (SLM), and binder jetting (“fluid-binder-on-powder” systems), among others.

Methods of forming a 3D article or object described herein can include forming the 3D article from a plurality of layers of build materials described herein in a layer-by-layer manner. Thus, in some embodiments, the first build material and the second build material are provided in a layer-by-layer process. In some embodiments, layer formation is administered via deposition and curing of one or more layers of the build material(s). Methods of forming a 3D article by additive manufacturing can also include forming the article in a manner other than a layer-by-layer manner.

In some embodiments, a method comprises providing a first build material (“base material”) and a second build material. Providing the first build material and the second build material, in some embodiments, comprises selecting the first build material and the second build material such that printing parameters can remain unchanged when switching between build materials. Such parameters may include, e.g., printing speed, power of applied curing radiation, exposure time of applied curing radiation, wavelength of applied curing radiation, cure depth, layer thickness, and/or build material deposition or replenishment settings (e.g., in the case of pumped or jetted build materials or build materials used to print a part from within a vat or other system in which the printed part is surrounded or encased by non-cured build material, as the part is being formed, such parameters may include pump settings such as pump distance and pump time). Other printing parameters are also possible, as readily understood by one of ordinary skill in the art.

In some embodiments, providing the first build material and the second build material comprises selecting the first build material and the second build material such that the build materials have at least one property that differs from each other by 10% or less (e.g., as described in Section I above). In some embodiments, providing the first build material and the second build material comprises selecting the first build material and the second build material such that the build materials have at least one property that differs from each other by 9% or less, 8% or less, 7% or less, 6% or less, 5% or less, 4% or less, 3% or less, 2% or less, or 1% or less. Providing the first and second build materials, in some embodiments, comprises selecting the first and second build materials such that the build materials have more than one property that differs from each other by 10% or less, 9% or less, 8% or less, 7% or less, 6% or less, 5% or less, 4% or less, 3% or less, 2% or less, or 1% or less (e.g., as described in Section I above).

Any build material not inconsistent with the objectives of this disclosure may be employed as the first and/or second build material in a method described herein. For instance, in some embodiments, the first and second build materials can be any of the first and second build materials described hereinabove in Section I of this disclosure, respectively. In some embodiments, the first build material and the second build material do not have identical chemical compositions. In some embodiments, the first build material is a first polymerizable liquid, and the second build material is a second polymerizable liquid that differs from the first polymerizable liquid.

Furthermore, any property not inconsistent with the objectives of the present disclosure may be selected as the one or more properties that differs between the first build material and the second build material by 10% or less. In some embodiments, any of the properties described in Section I hereinabove may be selected as the one or more properties that differ between the first build material and the second build material by 10% or less. For instance, in some embodiments, the one or more properties that differ between the first build material and the second build material by 10% or less, 9% or less, 8% or less, 7% or less, 6% or less, 5% or less, 4% or less, 3% or less, 2% or less, or 1% or less can be one or more of: surface tension at a temperature T, wettability at a temperature T, chemical reactivity at a temperature T, melting point onset temperature, total optical absorbance or light penetration depth at a wavelength λ, photocuring working curve at a wavelength λ, surface tension at printing temperature, surface tension at 25° C., phase transition temperature, sintering temperature or temperature range, absorption or reflection of a laser light, average particle size, wettability of powder relative to binder, and/or chemical reactivity between powder and binder.

In some embodiments, providing the first build material comprises retaining the first build material in a fluid state in a first container. In some embodiments, providing the second build material comprises retaining the second build material in a fluid state in a second container.

A method as described herein comprises, in some embodiments, selectively consolidating or solidifying layers of the first build material and layers of the second build material to form a 3D article. In some embodiments, layers of the first build material and layers of the second build material are selectively consolidated or solidified using the same printing parameters.

In some embodiments, selectively consolidating or solidifying layers of the first build material and layers of the second build material comprises forming regions of a first type (“first regions”) and regions of a second type (“second regions”) within the 3D article. For instance, in some embodiments, when consolidated into layers of a printed part, the first and second build materials form first regions and second regions which, upon completion of the printed part, have at least one property that differs (i.e., the first and second regions differ from each other at least in terms of one property). As readily understood by one of ordinary skill in the art, differing regions can define or form differing voxels (or groups of voxels) of the printed part. As one simple example, for instance, a first region may form an outer region of a printed part (e.g., a spherical outer “shell”), and a second region may form an inner region of the printed part (e.g., an inner spherical “core”). Many other arrangements are also possible, however, and the size and shape of a given region is not particularly limited.

Moreover, in some embodiments, regions of the first type and regions of the second type have at least one property that differs by at least 20%. In some embodiments, regions of the first type and regions of the second type have at least one property that differs by at least 25%, at least 30%, at least 35%, at least 40%, at least 45%, or at least 50%. Any property not inconsistent with the objectives of the present application may differ between the first and second regions, including as described above.

In some embodiments, the regions of the first type and the regions of the second type also have at least one property that differs by less than 10%. In some embodiments, the regions of the first type and the regions of the second type have at least one property that differs by less than 9%, less than 8%, less than 7%, less than 6%, less than 5%, less than 4%, less than 3%, less than 2%, or less than 1%. Any property not inconsistent with the objectives of the present application may differ between the first and second regions by at less than 10%, provided that the property that differs by less than 10% is different from the property that differs by at least 20% (as described above in Section I).

In some embodiments, selectively consolidating or solidifying layers of the first build material and layers of the second build material comprises providing a first build material having a penetration depth (Dₚ) and a critical energy (E_{c}) at a wavelength λ, providing a second build material having a penetration depth (Dₚ) and a critical energy (E_{c}) at the wavelength λ, and selectively curing a portion of each build material using incident curing radiation having a Gaussian distribution of wavelengths and a peak wavelength at the wavelength λ. Selectively curing a portion of each build material can include irradiating each build material with an electromagnetic radiation source or photocuring each build material (including with curing radiation described hereinabove). Any electromagnetic radiation source not inconsistent with the objectives of the present disclosure may be used, e.g., an electromagnetic radiation source that emits UV, visible or infrared light. For example, in some embodiments, the electromagnetic radiation source can be one that emits light having a wavelength from about 300 nm to about 900 nm, e.g., a Xe arc lamp.

In some embodiments, a method as described herein is a photocuring 3D printing method, and selectively consolidating or solidifying layers of the first build material and layers of the second build material comprises selectively photocuring a portion of the first build material and selectively photocuring a portion of the second build material. In some embodiments, selectively photocuring a portion of the first build material and selectively photocuring a portion of the second build material comprises using incident curing radiation having a Gaussian distribution of wavelengths and a peak wavelength at the wavelength λ.

In some embodiments, a method as described herein is an SLS 3D printing method, and selectively consolidating or solidifying layers of the first build material and layers of the second build material comprises sintering the layers of the first build material and the layers of the second build material.

In some embodiments, a method as described herein is an FDM printing method, SLM printing method, or binder jetting printing method. In some embodiments, selectively consolidating or solidifying layers of the first build material and layers of the second build material comprises depositing layers of the first build material and layers of the second build material in a molten or fluid state and subsequently freezing or partially freezing the layers of the first build material and the layers of the second build material. In some embodiments, selectively consolidating or solidifying layers of the first build material and layers of the second build material comprises melting and subsequently refreezing or partially refreezing the layers of the first build material and the layers of the second build material.

It is to be understood that methods of printing a 3D article described herein can include or encompass many different printing methods without deviating from the objectives of the invention. For example, in some instances, a MJP method of printing a 3D article comprises selectively depositing layers of each build material described herein in a fluid state onto a substrate, such as a build pad of a 3D printing system. A method described herein can also comprise curing the layers of each build material, including with curing radiation described above (such as curing radiation having a peak wavelength λ). Moreover, curing can comprise polymerizing one or more polymerizable moieties or functional groups of one or more components of each build material. In some cases, a layer of deposited build material is cured prior to the deposition of another or adjacent layer of build material. Additionally, curing one or more layers of deposited build material, in some embodiments, is carried out by exposing the one or more layers to electromagnetic radiation, such as UV light, visible light, or infrared light, as described above. In other words, it is possible to form a 3D article from build materials as described herein using a variety of methods, including, for example, vat polymerization methods (such as SLA methods) and/or material deposition methods (such as MJP). Further details regarding various methods, including material deposition methods and vat polymerization methods, are provided below. Additional details regarding various additive manufacturing methods that may be used in some embodiments described herein can be found in the following documents, each of which are incorporated by reference herein, in their entireties: U.S. Pat. Nos. 4,575,330; 4,863,538; 5,121,329; 5,164,128; 5,167,882; 5,182,056; 5,182,170; 5,192,559; 5,203,944; 5,204,055; 5,252,264; 5,260,009; 5,340,433; 5,597,589; 5,885,511; 5,904,889; 6,375,874; 6,416,850; 6,558,606; 6,866,807; 7,291,002; 7,513,596; 7,614,866; 7,767,132; 7,785,093; 7,795,349; 7,906,061; 7,931,460; 7,971,991; 8,105,066; 8,105,527; 8,119,053; 8,318,076; 8,465,689; 8,509,933; 8,569,398; 8,703,037; 8,876,513; 9,034,237; 9,353,284; 9,469,057; 9,533,451; 10,695,992; 10,773,305; 11,135,679; 11,203,151; 11,305,480; 11,779,472; U.S. Patent Application Publication 2008/0226346A1; International Patent Publication W_{O}1990/015674A1; International Patent Publication W_{O}1991/006378A1; International Patent Publication W_{O}1993/008928A1; and International Patent Publication W_{O}1993/019019A1.

### A. Material Deposition Methods

In a material deposition method, one or more layers of build materials as described herein are selectively deposited onto a substrate and cured. Curing of the build materials may occur after selective deposition of one layer, each layer, several layers, or all layers of build materials.

In some instances, build materials described herein are selectively deposited in a fluid state onto a substrate, such as a build pad of a 3D printing system. Selective deposition may include, for example, depositing the build materials according to preselected CAD parameters or other digital parameters corresponding to the desired article. For example, in some embodiments, a CAD file drawing (or other digital parameters) corresponding to a desired 3D article to be printed is generated and sliced into a sufficient number of horizontal slices. Then, the build materials are selectively deposited, layer by layer, according to the horizontal slices of the CAD file drawing (or other digital parameters) to print the desired 3D article. A “sufficient” number of horizontal slices is the number necessary for successful printing of the desired 3D article, e.g., to produce it accurately and precisely.

Further, in some embodiments, a preselected amount of each build material is heated to the appropriate temperature and jetted through a print head or a plurality of print heads of a suitable inkjet printer to form each layer on a print pad in a print chamber. In some cases, each layer of each build material is deposited according to preselected CAD parameters or other parameters. A suitable print head to deposit the build materials, in some embodiments, is a piezoelectric print head. Additional suitable print heads for the deposition of build materials described herein are commercially available from a variety of inkjet printing apparatus manufacturers. For example, Xerox, Hewlett Packard, or Ricoh print heads may be used in some instances.

Additionally, in some embodiments, build materials described herein remain substantially fluid upon deposition. Alternatively, in other instances, the build materials exhibit a phase change upon deposition and/or solidify upon deposition. Moreover, in some cases, a temperature of the printing environment can be controlled so that jetted droplets of a build material solidify on contact with the receiving surface. In other embodiments, the jetted droplets of ink do not solidify on contact with the receiving surface, remaining in a substantially fluid state. Additionally, in some instances, after each layer is deposited, the deposited material is planarized and cured with electromagnetic (e.g., UV, visible, or infrared light) radiation prior to the deposition of the next layer. Optionally, several layers can be deposited before planarization and curing, or multiple layers can be deposited and cured, followed by one or more layers being deposited and then planarized without curing. Planarization corrects the thickness of one or more layers prior to curing the material by evening the dispensed material to remove excess material and create a uniformly smooth exposed or flat up-facing surface on the support platform of the printer. In some embodiments, planarization is accomplished with a wiper device, such as a roller, which may be counter-rotating in one or more printing directions but not counter-rotating in one or more other printing directions. In some cases, the wiper device comprises a roller and a wiper that removes excess material from the roller. Further, in some instances, the wiper device is heated. It should be noted that the consistency of the jetted ink described herein prior to curing, in some embodiments, should desirably be sufficient to retain its shape and not be subject to excessive viscous drag from the planarizer.

Layered deposition of each build material can be repeated until the 3D article has been formed. In some embodiments, a method of printing a 3D article further comprises removing the second build material from the first build material.

Curing of the build materials may occur after selective deposition of one layer of build material, of each layer of build material, of several layers of build materials, or of all layers of the build materials necessary to print the desired 3D article. In some embodiments, a partial curing of the build materials is performed after selective deposition of one layer of build material, of each layer of build material, of several layers of build materials, or of all layers of the build materials necessary to print the desired 3D article. A “partially cured” build material, for reference purposes herein, is one that can undergo further curing. For example, a partially cured build material is up to about 30% polymerized or cross-linked or up to about 50% polymerized or cross-linked. In some embodiments, a partially cured build material is up to about 60%, up to about 70%, up to about 80%, up to about 90%, or up to about 95% polymerized or cross-linked.

Partial curing of the build materials can include irradiating the build materials with an electromagnetic radiation source or photocuring the build materials (including with curing radiation described hereinabove). Any electromagnetic radiation source not inconsistent with the objectives of the present disclosure may be used, e.g., an electromagnetic radiation source that emits UV, visible or infrared light. For example, in some embodiments, the electromagnetic radiation source can be one that emits light having a wavelength from about 300 nm to about 900 nm, e.g., a Xe arc lamp.

Further, in some embodiments, a post-curing is performed after partial curing is performed. For example, in some cases, post-curing is carried out after selectively depositing all layers of build materials necessary to form a desired 3D article, after partially curing all layers of the build materials, or after both of the foregoing steps have been performed. Moreover, in some embodiments, post-curing comprises photocuring, including with curing radiation described hereinabove having a peak wavelength λ. Again, any electromagnetic radiation source not inconsistent with the objectives of the present disclosure may be used for a post-curing step described herein. For example, in some embodiments, the electromagnetic radiation source can be a light source that has a higher energy, a lower energy, or the same energy as the electromagnetic radiation source used for partial curing. In some cases wherein the electromagnetic radiation source used for post-curing has a higher energy (i.e., a shorter wavelength) than that used for partial curing, a Xe arc lamp can be used for partial curing and a Hg lamp can be used for post-curing.

Additionally, after post-curing, in some cases, the deposited layers of build materials are at least about 80% polymerized or cross-linked, or at least about 85% polymerized or cross-linked. In some embodiments, the deposited layers of ink are at least about 90%, at least about 95%, at least about 98%, or at least about 99% polymerized or cross-linked. In some instances, the deposited layers of ink are about 80-100%, about 80-99%, about 80-95%, about 85-100%, about 85-99%, about 85-95%, about 90-100%, or about 90-99% polymerized or cross-linked.

### B. Vat Polymerization Methods

It is also possible to form a 3D article from build materials described herein using a vat polymerization method, such as an SLA method. Thus, in some cases, a method of printing a 3D article described herein comprises retaining a first build material in a fluid state in a first container, retaining a second build material in a fluid state in a second container (or in the first container), and selectively applying energy (particularly, for instance, the curing radiation having the peak wavelength λ) to the first build material in the first container and the second build material in the second container (or in the first container) to solidify at least a portion of a fluid layer of the build materials, thereby forming one or more solidified layers that define one or more cross-sections of the 3D article.

It is to be understood that a method as described herein is not limited to a first build material in a first container and a second build material in a second container, but may also include providing n different build materials in n different containers (or in fewer than n containers).

Additionally, a method described herein can further comprise raising or lowering the solidified layer of each build material to provide a new or second fluid layer of unsolidified build material at the surface of the fluid build material in each container, followed by again selectively applying energy (e.g., the curing radiation) to the build material in each container to solidify at least a portion of the new or second fluid layer of the build material to form a second solidified layer that defines a second cross-section of the 3D article. Further, the first and second cross-sections of the 3D article can be bonded or adhered to one another in the z-direction (or build direction corresponding to the direction of raising or lowering recited above) by the application of the energy for solidifying the build material. Moreover, in some instances, the electromagnetic radiation has an average wavelength of 300-900 nm, and in other embodiments the electromagnetic radiation has an average wavelength that is less than 300 nm. In some cases, the curing radiation is provided by a computer controlled laser beam. In addition, in some cases, raising or lowering a solidified layer of a build material is carried out using an elevator platform disposed in each container of fluid build material. A method described herein can also comprise planarizing a new layer of fluid build material provided by raising or lowering an elevator platform. Such planarization can be carried out, in some cases, by a wiper or roller.

It is further to be understood that the foregoing process can be repeated a desired number of times to provide the 3D article. For example, in some cases, this process can be repeated “n” number of times, wherein n can be up to about 100,000, up to about 50,000, up to about 10,000, up to about 5000, up to about 1000, or up to about 500. Thus, in some embodiments, a method of printing a 3D article described herein can comprise selectively applying energy (e.g., curing radiation of peak wavelength λ) to first and second build materials, in first and second containers, to solidify at least a portion of an nth fluid layer of each build material, thereby forming an nth solidified layer that defines an nth cross-section of the 3D article, raising or lowering the nth solidified layers of first and second build materials to provide an (n+1)th layer of unsolidified first build material and (n+1)th layer of unsolidified second build material at the surface of each fluid build material in each container, selectively applying energy to the (n+1)th layers of first and second build materials in the first and second containers to solidify at least a portion of the (n+1)th layers to form an (n+1)th solidified layer of each build material, which defines an (n+1)th cross-section of the 3D article, raising or lowering the (n+1)th solidified layer of each build material to provide an (n+2)th layer of unsolidified first build material at the surface of the fluid build material in the first container, and an (n+2)th layer of unsolidified second build material at the surface of the fluid build material in the second container, and continuing to repeat the foregoing steps to form the 3D article. Further, it is to be understood that one or more steps of a method described herein, such as a step of selectively applying energy (e.g., curing radiation described herein) to a layer of build material, can be carried out according to an image of the 3D article in a computer-readable format. General methods of 3D printing using stereolithography are further described, inter alia, in U.S. Pat. Nos. 5,904,889 and 6,558,606.

In a vat polymerization method such as described above, each of the first and second build materials may be partially cured. For example, in some embodiments, selectively applying energy to the first build material in the first container and to the second build material in the second container to solidify at least a portion of a fluid layer of each build material may include partially curing at least a portion of a fluid layer of each build material. In other embodiments, partial curing of at least a portion of a fluid layer of each build material may occur after a first layer of each build material is provided and solidified, before or after a second layer of each build material is provided or solidified, or before or after one, several, or all subsequent layers of each build material are provided or solidified. Additionally, in some embodiments of a vat polymerization method described herein, after partial curing or after the desired 3D article is formed, post-curing may be performed, as described hereinabove. The desired 3D article may be, for example, an article that corresponds to the design in a CAD file or other digital image or representation of the article.

In some embodiments of a method of printing a three-dimensional article described herein, the layers of the build materials can be deposited according to preselected computer aided design (CAD) parameters or other similar parameters. That is, in some embodiments, the first build material and the second build material are selectively consolidated or solidified according to preselected computer aided design (CAD) parameters or other digital parameters. In some embodiments, the layers of the build materials can be deposited according to an image of the 3D article in a computer readable format during formation of the three-dimensional article. Moreover, in some cases, one or more layers of the build materials described herein has a thickness of about 10 μm to about 100 μm, about 10 μm to about 80 μm, about 10 μm to about 50 μm, about 20 μm to about 100 μm, about 20 μm to about 80 μm, or about 20 μm to about 40 μm. Other thicknesses are also possible.

In one aspect, the methods described herein allow for multiple build materials to be used in conjunction during a single print job. In some embodiments, layers of the first build material are selectively consolidated or solidified and layers of the second build material are selectively consolidated or solidified using the same printing parameters. In other words, in some embodiments, one or more printing parameters are not changed (i.e., remain unchanged) in between printing with one build material and/or the other, and/or based on which build material is being used. Various mechanisms can also be used to switch between one build material and another (whether using material deposition methods, vat methods, or other methods), such as mechanisms described in the documents referenced above, e.g., multiple printheads, each connected to or “fed by” a reservoir of a different build material; or “feeding” or replenishing a vat or build chamber with a different or “switched” build material in between solidifying one layer and solidifying the subsequent layer, using feedstocks of different liquids or powders as build materials, delivered via chutes, vacuum, rollers, or other mechanisms known to one of ordinary skill in the art or further developed in the future.

Additionally, it is to be understood that the methods described herein are not limited to a first build material and a second build material, and can include n additional build materials which undergo one or more of the method steps as described hereinabove. As such, in some embodiments, a method described herein further comprises providing n additional build materials, and selectively consolidating or solidifying layers of the n additional build material(s) as described hereinabove, so as to form the 3D article, wherein n can be an integer from 1-1000, 1-500, or 1-100. The n additional build materials can be selected from any of the build materials discussed elsewhere in this disclosure, and can have any of the characteristics previously discussed. In some embodiments, the n build materials do not have the same chemical compositions as the first build material, the second build material, or one another.

A method as described herein, in some embodiments, provides a 3D article comprising multiple build materials having different properties, which can be obtained without changing printing parameters, wherein the article has different areas with different properties.

A system for printing a three-dimensional article is also provided. A system for printing as described herein comprises at least a first build material and a second build material. The first and second build materials can be selected from any of the first and second build materials described in Section I hereinabove. It is to be understood that a system as described herein is not limited to first and second build materials, and may comprise n additional build materials as described above.

### III. 3D Articles

In another aspect, a printed three-dimensional article is disclosed. An article as described herein can be formed from a kit for additive manufacturing as described in Section I hereinabove. In some embodiments, a printed 3D article is formed from a first build material and a second build material. Any first and/or second build materials described hereinabove in Section I may be used as the first and second build materials of the printed 3D article, respectively. It is to be understood that articles as described herein are not limited to only having a first and second build material, but may include n additional build materials as described above.

An article as described herein can be manufactured via any of the methods of 3D printing described in Section II hereinabove.

Moreover, an article described herein, in some embodiments, comprises or is formed from multiple build materials having different properties, obtained without changing printing parameters. Additionally, in some instances, the article comprises different areas with different properties.

Some specific embodiments of kits are further illustrated in the following non-limiting Examples.

### EXAMPLES

Table 1 provides formulations of build materials that may comprise a kit according to some embodiments described herein. It is to be understood that all components of a given Formula add up to 100 wt. %. For the formulations provided in Table 1, the surface tensions and wettabilities of Formula 1 and each of Formulas 2, 3, 4, 5, and 6 differed by less than 10% (within the normal variation within the relevant additive manufacturing technology).

TABLE 1
Formulations of Build Materials That May Comprise a Kit.

| Component | Formula 1 | Formula 2 | Formula 3 | Formula 4 | Formula 5 | Formula 6 |
|---|---|---|---|---|---|---|
| Polyether urethane | 32 | 35 | 30 | 24 | 30 | 30 |
| methacrylate | | | | | | |
| Cyclopolymerizable | 20 | 15 | 15 | 12 | 10 | 10 |
| additive | | | | | | |
| Acryloyl morpholine | 15 | 25 | 30 | 24 | — | — |
| Dicylcopentanyl | — | — | — | — | — | 10 |
| methacrylate | | | | | | |
| Vinyl methyl | — | — | — | — | — | — |
| oxazolidinone | | | | | | |
| Isocyanurate acrylate | 18 | 20 | 20 | 16 | 10 | 10 |
| Polyallyl isocyanurate | — | — | — | — | 46 | 36 |
| Dibromocrecyl | — | — | — | — | — | — |
| diglycidyl ether | | | | | | |
| Cyclocarbonate | 10 | — | — | — | — | — |
| (meth)acrylate | | | | | | |
| monomer | | | | | | |
| Core/Shell particle resin | — | — | — | 20 | — | — |
| Colorant | 0.5 | 0.5 | 0.5 | 0.4 | 0.1 | 0.1 |
| UV absorber/Light | 1.2 | 1.2 | 1.2 | 0.96 | 1 | 1 |
| stabilizer | | | | | | |
| Photoinitiator | 2.8 | 2.8 | 2.8 | 2.24 | 2 | 2 |
| Dispersant | 0.5 | 0.5 | 0.5 | 0.4 | 0.9 | 0.9 |

Table 2 provides physical properties of 3D articles printed using Formulas 1-6. As shown in Table 2, as compared to Formula 1, the elongation (%) at break values when measured in accordance to ASTM D638 of Formulas 2-6 differ from Formula 1 by at least 20%.

TABLE 2
Properties of 3D Printed Articles Formed from
Build Materials of a Kit from Table 1.

| | Formula | Formula | Formula | Formula | | Formula |
|---|---|---|---|---|---|---|
| | 1 | 2 | 3 | 4 | Formula | 6 |
| Elongation (%) | 9 | 17 | 12 | 12 | 5 | 6 |
| @ Break | | | | | | |
| Percent | — | 62% | 29% | 29% | 57% | 40% |
| difference | | | | | | |
| compared to | | | | | | |
| Formula 1 | | | | | | |

Table 3 provides formulations of build materials that may comprise a kit according to some embodiments described herein. It is to be understood that in Table 3, all components of a given Formula add up to 100 wt. %. All of the formulations provided in Table 3 had substantially the same surface tension and wettability (difference of less than 10% among all formulations) (within the normal variation within the relevant additive manufacturing technology).

TABLE 3
Formulations of Build Materials That May Comprise a Kit.

| | Formula | Formula | Formula |
|---|---|---|---|
| Component | 7 | 8 | 9 |
| Polyether urethane methacrylate | 27 | 30 | 30 |
| Cyclopolymerizable additive | 10 | 10 | 10 |
| Dicylcopentanyl methacrylate | — | — | 10 |
| Vinyl methyl oxazolidinone | 14 | — | — |
| Isocyanurate acrylate | 10 | 10 | 10 |
| Polyallyl isocyanurate | 20 | 46 | 36 |
| Cyclocarbonate (meth)acrylate | — | — | — |
| monomer | | | |
| Core/Shell particle resin | 15 | — | — |
| Colorant | 0.5 | 0.5 | 0.5 |
| UV Absorber/Light stabilizer | 1 | 1 | 1 |
| Photoinitiator | 2 | 2 | 2 |
| Dispersant | 0.5 | 0.5 | 0.5 |

Table 4 provides physical properties of 3D articles printed using Formulas 7-9. As shown in Table 4, compared to Formula 7, the impact strength of Formulas 8 and 9 differ from Formula 7 by at least 20%.

TABLE 4
Properties of 3D Printed Articles Formed from
Build Materials of a Kit from Table 3.

| | Formula 7 | Formula 8 | Formula 9 |
|---|---|---|---|
| Impact Strength (J/m) | 19 | 12 | 9 |
| Percent difference compared | — | 45% | 71% |
| to Formula 7 | | | |

Table 5 provides formulations of build materials that may comprise a kit according to some embodiments described herein. It is to be understood that all components of a given Formula add up to 100 wt. %. All of the formulations provided in Table 5 had substantially the same surface tension and wettability (difference of less than 10% among all formulations) (within the normal variation within the relevant additive manufacturing technology).

TABLE 5
Formulations of Build Materials That May Comprise a Kit.

| Component | Formula 10 | Formula 11 | Formula 12 | Formula 13 | Formula 14 |
|---|---|---|---|---|---|
| Urethane acrylate oligomer | 24.5 | 25.4 | 25 | 25 | 25 |
| Urethane acrylate monomer | 0 | 0 | 0 | 0 | 0 |
| Cyclopolymerizable additive | 19.5 | 20.3 | 20 | 20 | 20 |
| Tricyclodecane dimethanol diacrylate | 17.5 | 15.3 | 5 | 10 | 15 |
| Dicyclopentanyl methacrylate | 14.7 | 15.3 | 18 | 18 | 18 |
| Monofunctional monomeric acrylate | 21.8 | 21.7 | 30 | 25 | 20 |
| Photoinitiator | 2 | 2 | 2 | 2 | 2 |

Table 6 provides physical properties of 3D articles printed using Formulas 10-14. As shown in Table 6, compared to Formula 10, the Charpy impact 1J values when measured in accordance with ISO 179 of Formulas 11-14 and 9 differ from Formula 10 by at least 20%.

TABLE 6
Properties of 3D Printed Articles Formed from Build Materials of a Kit from Table 5.

| | Formula 10 | Formula 11 | Formula 12 | Formula 13 | Formula 14 |
|---|---|---|---|---|---|
| Charpy impact 1 J (kJ/m³) (ISO 179) | 5 | 4 | 21 | 15 | 9 |
| Percent difference compared to Formula 10 | — | 22% | 123% | 100% | 57% |

Tables 7-8 provides formulations of build materials that may comprise a kit according to some embodiments described herein. Table 7 indicates the wt. % of each component stated in Table 8. It is to be understood that all components of a given Formula add up to 100 wt. %. In Table 8, MA-PEG-MA has the structure below:

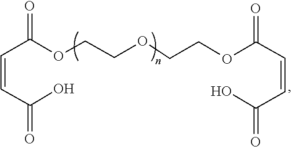

wherein the compound described is formed from the reaction of the poly(ethylene glycol) (PEG) indicated in the table and maleic anhydride (MA). Moreover, in Table 8, the following abbreviations are used: “HEAA” refers to N-hydroxy ethyl acrylamide, “HPA” refers to hydroxypropyl acrylate, “HBA” refers to hydroxybutyl acrylate, “QY” refers to quinoline yellow, and “Sodium TPO-L” refers to sodium 2,4,6-trimethylbenzoyldiphenylphosphine oxide. Additionally, for the formulations provided in Tables 7-8, the difference between the surface tension and wettability of Formula 15 and the surface tension and wettability of each of Formulas 16-19 was less than 10% (within the normal variation within the relevant additive manufacturing technology).

TABLE 7
Formulations of Build Materials That May Comprise a Kit.

| | Formula | Formula | Formula | Formula | Formula |
|---|---|---|---|---|---|
| Component | 15 | 16 | 17 | 18 | 19 |
| Curable Compound | 12 | 20 | 30 | 35 | 35 |
| Acrylate Component | 39.5 | 40 | 50 | 50 | 50 |
| Colorant | 0.1 | 0.4 | 0.4 | 0.4 | 0.4 |
| Photoinitiator | 1.4 | 1.8 | 1.8 | 1.8 | 1.8 |
| Water | 47 | 37.8 | 17.8 | 12.8 | 12.8 |

TABLE 8
Formulations of Build Materials That May Comprise a Kit.

| Component | Formula 15 | Formula 16 | Formula 17 | Formula 18 | Formula 19 |
|---|---|---|---|---|---|
| Curable | MA-PEG200- | MA-PEG200- | MA-PEG200- | MA-PEG600- | MA-PEG1000- |
| Compound | MA | MA | MA | MA | MA |
| Acrylate | HEAA + HPA | HPA + HBA + | HPA + HBA + | HPA + HBA + | HPA + HBA + |
| Component | (5 + 34.5) | HEAA (10 + | HEAA (15 + | HEAA (15 + | HEAA (15 + |
| | | 20 + 10) | 25 + 10) | 25 + 10) | 25 + 10) |
| Colorant | QY | QY | QY | QY | QY |
| Photoinitiator | Sodium | Sodium | Sodium | Sodium | Sodium |
| | TPO-L | TPO-L | TPO-L | TPO-L | TPO-L |

Table 9 provides physical properties of 3D articles printed using Formulas 15-19. As shown in Table 9, compared to Formula 15, the elongation at break values of Formulas 16-19 differ from Formula 15 by at least 20%.

TABLE 9
Properties of 3D Printed Articles Formed from
Build Materials of a Kit from Tables 7 and 8.

| | Formula | Formula | Formula | Formula | Formula |
|---|---|---|---|---|---|
| | 15 | 16 | 17 | 18 | 19 |
| Elongation @ Break (%) | 250 | 170 | 190 | 190 | 170 |
| Percent difference | — | 38% | 27% | 27% | 38% |
| compared to Formula 15 | | | | | |

Table 10 provides formulations of build materials that may comprise a kit according to some embodiments described herein. It is to be understood that all components of a given Formula add up to 100 wt. %. The oligomeric curable material of Formula 20 was a mixture of aliphatic polyester urethane acrylate, aliphatic urethane diacrylate, and aliphatic urethane triacrylate in approximately equal amounts. The oligomeric curable material of Formula 21 was polyether urethane methacrylate having a T_{g} of 75° C. and a dynamic viscosity of about 6,800 cP at 60° C. The oligomeric curable material of Formula 22 was a 15:15 mixture (by weight) of aliphatic polyester urethane diacrylate having a T_{g} of −60° C. and a dynamic viscosity of 200,000 cP at 50° C. and polyester urethane acrylate having a T_{g} of 79° C. and a dynamic viscosity of 150,000 cP at 50° C. The additional curable material in Formula 20 and Formula 21 was a combination of 2-pheoxyethyl acrylate, acryloyl morpholine, (5-ethyl-1,3-dioxan-5-yl)methyl acrylate, trimethylene glycol dimethacrylate (TEGDMA), and trimethyl cyclohexyl acrylate. The additional curable material of Formula 22 was a 5:27 mixture (by weight) of isobornyl acrylate and (5-ethyl-1,3-dioxan-5-yl)methyl acrylate, respectively. The photoinitiator in Formula 20, Formula 21, and Formula 22 was Irgacure 819.

For the formulations provided in Table 10, the difference between the surface tension and wettability of Formula 20 and the surface tension and wettability of each of Formulas 21 and 22 was less than 10% (within the normal variation within the relevant additive manufacturing technology).

TABLE 10
Formulations of Build Materials That May Comprise a Kit.

| | Formula | Formula | Formula |
|---|---|---|---|
| Component | 20 | 21 | 22 |
| Oligomeric curable material | 45 | 50 | 45 |
| Cyclocarbonate (meth)acrylate | 20 | 20 | 20 |
| monomer | | | |
| Additional curable material | 32 | 27 | 32 |
| Photoinitiator | 3 | 3 | 3 |

Table 11 provides physical properties of 3D articles printed using Formulas 20-22. As shown in Table 9, compared to Formula 20, the notched Izod impact strength values according to ASTM D256 of Formulas 21 and 22 differ from Formula 20 by at least 20%.

TABLE 11
Properties of 3D Printed Articles Formed from
Build Materials of a Kit from Table 10.

| | Formula | Formula | Formula |
|---|---|---|---|
| | 20 | 21 | 22 |
| Notched Izod impact strength (J/m) | 80 | 100 | 50 |
| Percent difference compared to | — | 22% | 46% |
| Formula 20 | | | |

Table 12 provides formulations of build materials that may comprise a kit according to some embodiments described herein. It is to be understood that all components of a given Formula add up to 100 wt. %. For Formula 23, the monofunctional curable material was a mixture of GENOMER 1122 and SR506. For Formulas 24-27, the monofunctional curable material was a mixture of GENOMER 1122 and SR423A. For Formulas 23-27, the difunctional curable material was EBECRYL 8402. For Formulas 23-27, the liquid rubber was a butadiene acrylonitrile copolymer, either HYPRO CTBN or HYPRO VTBNX. For Formulas 23, 26, and 27, the photoinitiator was Irgacure 819. For Formulas 24 and 25, the photoinitiator was TPO. The stabilizer for Formulas 23-27 was BHT. The non-curable viscosity modifying agent (“VMA”) for Formulas 24-27 was coconut oil. The colorant for Formula 23 was PENN COLOR 9B898 and UVDH107 for Formula 27.

For the formulations provided in Table 12, the difference between the surface tension and wettability of Formula 23 and the surface tension and wettability of Formulas 24-27 was less than 10% (within the normal variation within the relevant additive manufacturing technology).

TABLE 12
Formulations of Build Materials That May Comprise a Kit.

| | Formula | Formula | Formula | Formula | Formula |
|---|---|---|---|---|---|
| | 23 | 24 | 25 | 26 | 27 |
| Monofunctional | 84.7 | 80.7 | 80.7 | 77.5 | 77.4 |
| curable material | | | | | |
| Difunctional curable | 5 | 3 | 3 | 3 | 3 |
| material | | | | | |
| Liquid rubber | 8 | 9 | 9 | 9 | 9 |
| Photoinitiator | 2 | 1 | 1 | 2 | 2 |
| Stabilizer | 0.2 | 0.2 | 0.2 | 0.5 | 0.5 |
| VMA | 0 | 6 | 6 | 8 | 8 |
| Colorant | 0.1 | 0 | 0 | 0 | 0.1 |

Table 13 provides physical properties of 3D articles printed using Formulas 23-27. As shown in Table 13, the Shore A hardness values according to ASTM D2240 of Formulas 24-27 differ from Formula 23 by at least 20%.

TABLE 13
Properties of 3D Printed Articles Formed from Build Materials of a Kit from Table 12.

| | Formula 23 | Formula 24 | Formula 25 | Formula 26 | Formula 27 |
|---|---|---|---|---|---|
| Shore A hardness | 40 | 30 | 30 | 30 | 20 |
| Percent difference | — | 29% | 29% | 29% | 67% |
| compared to Formula 23 | | | | | |

Table 14 provides formulations of build materials that may comprise a kit according to some embodiments described herein. Formulations in Table 14 may be used for SLS. It is to be understood that all components of a given Formula add up to 100 wt. %. In Table 14, Duraform PA is unfilled nylon powder, Vestamelt 3261 is copolyamide hotmelt adhesive pellets from Degussa, A60 is untreated wollstonite from MIAL-Feldmeilen of Switzerland, which has an aspect ratio from about 15:1 to 20:1, and Alument H30 is substantially spherical aluminum powder.

For each of the formulations provided in Table 14, the sintering temperature/window, the absorption/reflection of the relevant laser light (for heating to the sintering temperature), and the average particle size were substantially the same (as described herein for the same or similar properties) (within the normal variation within the relevant additive manufacturing technology).

TABLE 14
Formulations of Build Materials That May Comprise a Kit.

| Component | Formula 28 | Formula 29 | Formula 30 |
|---|---|---|---|
| Duraform PA | 75% | 65% | 0% |
| Vestamelt 3261 | 0% | 0% | 75% |
| A60 | 25% | 10% | 25% |
| Alument H30 | 0% | 25% | 0% |

Table 15 provides physical properties of 3D articles printed using Formulas 28-30. As shown in Table 13, compared to Formula 28, the tensile strength values according to ISO 527 and HDT values as measured using ISO 25-2:2004 of Formulas 29-30 differ from Formula 28 by at least 20%.

TABLE 15
Properties of 3D Printed Articles Formed from
Build Materials of a Kit from Table 14.

| | Formula 28 | Formula 29 | Formula 30 |
|---|---|---|---|
| Tensile strength (MPa) | 40 | 30 | 30 |
| Percent difference compared | — | 29% | 29% |
| to Formula 28 | | | |
| HDT (° C.) | 160 | 130 | 130 |
| Percent difference compared | — | 21% | 21% |
| to Formula 28 | | | |

For Formulas 1-14 above (and other compositions, particularly photocurable compositions), the following print parameters can be used, without modification in between the use of one build material and another build material of a given kit, as shown in Table 16. Such parameters may be particularly suitable for use with photocurable compositions and additive manufacturing methods in which the printed part is surrounded or encased by non-cured build material, as the part is being formed in the printing process. Print parameters other than those described in Table 16 may also be used, as understood by one of ordinary skill in the art, and the parameters in Table 16 are not limiting.

TABLE 16
Example Print Parameters.

| | |
|---|---|
| Layer Thickness (μm) | 30-60 |
| Cure Depth (μm) | 50-200 |
| Curing Radiation Peak Wavelength (nm) | 365-425 |
| Curing Power (mW/cm²) | 5-50 |
| Curing Exposure Time (per layer) (seconds) | 0.5-5 |

In addition, working curves for five example build materials suitable for use in one or more kits described herein (e.g., a kit including one or more of Formulas 1-14) are shown in FIG. 4. The plot of working curves in FIG. 4 is analogous to the plots in FIGS. 1-3 described above. With reference to FIG. 4, five experimentally-derived working curves (410, 420, 430, 440, and 450) are shown. The Dₚ and E_{c} values of the working curves (410, 420, 430, 440, and 450) are also shown in table form in Table 17 below (rounded to one decimal place).

TABLE 17
Dp and Ec Values for Example Working Curves.

| Working Curve | Dₚ (mils) | E_{c} (mJ/cm²) |
|---|---|---|
| 410 | 8.5 | 13.0 |
| 420 | 8.4 | 13.3 |
| 430 | 5.0 | 9.1 |
| 440 | 7.3 | 12.9 |
| 450 | 5.5 | 11.0 |

It is to be understood that, in FIG. 4 and Table 17, the first working curve (410) is associated with a first build material, the second working curve (420) is associated with a second build material, the third working curve (430) is associated with a third build material, the fourth working curve (440) is associated with a fourth build material, and the fifth working curve (450) is associated with a fifth build material. The five differing build materials may, in some embodiments, be used as the first, second, third, fourth, and fifth build materials of a kit described herein, or a subset of the five differing build materials may be used as part of a kit or to form a kit. For example, the first build material and the second build material may be combined in a kit. Or, as another possibility, the third build material and the fifth build material may be combined in a different kit. Or, as yet another possibility, the second build material, fourth build material, and fifth build material may be combined in still another, different kit.

As seen from FIG. 4 and Table 17, each of the curves (410, 420, 430, 440, and 450) has a different slope (corresponding to the Dₚ of the build material) and a different x-intercept (corresponding to the E_{c} of the build material), though some (but not all) Dₚ values are within 1 mil of one another. Additionally, as illustrated in FIG. 4, various working curves (e.g., 440 and 450) intersect with one another within a preferred window described herein (e.g., at a point defined by an x-value of 2-40 mJ/cm² and a y-value of 10-50 mils). As stated above, such “sameness” or similarity of build materials can permit formation of a kit described herein, where one or more other properties or structural features of the build materials are different.

Some additional, non-limiting example embodiments are provided below.

Embodiment 1. A kit for use in additive manufacturing, the kit comprising a first build material and a second build material, wherein the first build material and the second build material do not have identical chemical compositions, wherein the first build material has a first surface tension and/or first wettability at a temperature T, wherein the second build material has a second surface tension and/or second wettability at the temperature T, wherein the first surface tension and/or first wettability and the second surface tension and/or second wettability, respectively, differ by 10% or less, wherein the first build material has a first chemical reactivity at the temperature T, a first melting point onset temperature, and/or a first total optical absorbance or light penetration depth at a wavelength λ, wherein the second build material has a second chemical reactivity at the temperature T, a second melting point onset temperature, and/or a second total optical absorbance or light penetration depth at the wavelength λ, wherein the first chemical reactivity at the temperature T, the first melting point onset temperature, and/or the first total optical absorbance or light penetration depth at the wavelength λ, and the second chemical reactivity at the temperature T, the second melting point onset temperature, and/or the second total optical absorbance or light penetration depth at the wavelength λ, respectively, differ by 10% or less.

Embodiment 2. The kit of Embodiment 1, wherein the first build material has a first surface tension at a temperature T, a first photocuring working curve at a wavelength λ, a first penetration depth (Dₚ) at the wavelength λ, and a first critical energy (E_{c}) at the wavelength λ, wherein the second build material has a second surface tension at the temperature T, a second photocuring working curve at the wavelength λ, a second Dₚ at the wavelength λ, and a second E_{c} at the wavelength λ, wherein the first surface tension differs from the second surface tension by 10% or less, wherein the first photocuring working curve and the second photocuring working curve intersect (e.g., within a window of 2-40 mJ/cm² exposure and 0-50 mils cure depth) or have Dₚ values that differ by 1 mil or less, and wherein, optionally, (1) the first Dₚ is between 2 and 10 mils, the second Dₚ is between 4 and 8 mils, the first E_{c} is between 2 and 15 mJ/cm², and the second E_{c} is between 4 and 15 mJ/cm²; (2) the first Dₚ is between 4 and 10 mils, the second Dₚ is between 4 and 8 mils, the first E_{c} is between 5 and 15 mJ/cm², and the second E_{c} is between 6 and 15 mJ/cm²; (3) the first Dₚ is between 2 and 7 mils, the second Dₚ is between 4 and 10 mils, the first E_{c} is between 2 and 10 mJ/cm², and the second E_{c} is between 4 and 15 mJ/cm²; (4) the first Dₚ is between 4 and 8 mils, the second Dₚ is between 4 and 8 mils, the first E_{c} is between 2 and 15 mJ/cm², and the second E_{c} is between 4 and 15 mJ/cm²; (5) the first Dₚ is between 4 and 7 mils, the second Dₚ is between 3 and 7 mils, the first E_{c} is between 2 and 20 mJ/cm², and the second E_{c} is between 4 and 25 mJ/cm²; (6) the first Dₚ is between 5 and 8 mils, the second Dₚ is between 5 and 8 mils, the first E_{c} is between 2 and 15 mJ/cm², and the second E_{c} is between 4 and 15 mJ/cm²; or (7) the first Dₚ is between 4 and 8 mils, the second Dₚ is between 5 and 10 mils, the first E_{c} is between 2 and 20 mJ/cm², and the second E_{c} is between 4 and 25 mJ/cm²; and optionally wherein the first Dₚ and the second Dₚ differ by no more than 20% or no more than 15%, and the first E_{c} and the second E_{c} differ by no more than 20% or no more than 15%.

Embodiment 3. The kit of any of the preceding Embodiments, wherein the first build material is a first polymerizable liquid and the second build material is a second polymerizable liquid that differs from the first polymerizable liquid.

Embodiment 4. The kit of Embodiment 3, wherein the first polymerizable liquid, when cured, and the second polymerizable liquid, when cured, have at least one property that differs by at least 20%.

Embodiment 5. The kit of Embodiments 3 or 4, wherein the first polymerizable liquid, when cured, and the second polymerizable liquid, when cured, have at least one property that differs by less than 10%.

Embodiment 6. The kit of any of the preceding Embodiments, wherein the second build material comprises at least one supplemental component that is not present in the first build material.

Embodiment 7. The kit of Embodiment 6, wherein the first build material and the second build material have identical chemical compositions, except for the supplemental component of the second build material.

Embodiment 8. The kit of Embodiments 6 or 7, wherein the supplemental component is present in the second build material in an amount of up to 30 wt. %, based on the total weight of the second build material.

Embodiment 9. The kit of any of the preceding Embodiments, wherein the first build material and/or the second build material comprises up to 80 wt. % oligomeric curable material, up to 80 wt. % monomeric curable material, up to 10 wt. % photoinitiator, and up to 40 wt. % one or more additional components, based on the total weight of the first build material and/or based on the total weight of the second build material.

Embodiment 10. The kit of any of the preceding Embodiments, wherein the first build material comprises, based on the total weight of the first build material, up to 80 wt. % oligomeric curable material, up to 80 wt. % monomeric curable material, up to 10 wt. % photoinitiator, and up to 40 wt. % one or more additional components, and wherein the second build material comprises, based on the total weight of the second build material, up to 80 wt. % oligomeric curable material, up to 80 wt. % monomeric curable material, up to 10 wt. % photoinitiator, up to 40 wt. % one or more additional components, and up to 30 wt. % supplemental component that is not present in the first build material.

Embodiment 11. The kit of Embodiment 10, wherein the oligomeric curable material of the first build material and the second build material are the same or different, the monomeric curable material of the first build material and the second build material are the same or different, the photoinitiator of the first build material and the second build material are the same or different, and the one or more additional components of the first build material and the second build material are the same or different.

Embodiment 12. The kit of any of the preceding Embodiments, further comprising n additional build materials having n additional surface tensions at the temperature T, n additional photocuring working curves at the wavelength λ, n additional Dₚ values at the wavelength λ, and n additional E_{c} values at the wavelength λ, wherein the n additional build materials do not have the same chemical compositions as the first build material, the second build material, or one another, wherein the n additional surface tensions differ from the first surface tension, the second surface tension, and one another by 10% or less, wherein the n additional photocuring working curves intersect with the first photocuring working curve, the second photocuring working curve, and with each other (e.g., within a window of 2-40 mJ/cm² exposure and 0-50 mils cure depth) or have Dₚ values that differ by 1 mil or less, and optionally wherein the n additional Dₚ values are each between 2 and 8 mils, between 2 and 10 mils, between 4 and 7 mils, between 4 and 8 mils, or between 5 and 10 mils; milsthe n additional E_{c} values are each between 2 and 10 mJ/cm², between 2 and 15 mJ/cm², between 2 and 20 mJ/cm², between 3 and 15 mJ/cm², between 4 and 15 mJ/cm², between 4 and 25 mJ/cm², between 5 and 15 mJ/cm², or between 6 and 15 mJ/cm²; and optionally wherein each of the n additional Dₚ values differ from one another (or from the first Dₚ) by no more than 20% or no more than 15%, and each of the n additional E_{c} values differ from one another (or from the first E_{c}) by no more than 20% or no more than 15%; and wherein n is an integer ranging from 1 to 100.

Embodiment 13. A method of printing a three-dimensional article comprising providing a first build material and a second build material according to the kit of any of the preceding Embodiments, and selectively consolidating or solidifying layers of the first build material and layers of the second build material to form the article.

Embodiment 14. The method of Embodiment 13, wherein selectively consolidating or solidifying layers of the first build material and layers of the second build material comprises forming regions of a first type and regions of a second type within the article, and the regions of the first type and the regions of the second type have at least one property that differs by at least 20%.

Embodiment 15. The method of Embodiment 14, wherein the regions of the first type and the regions of the second type have at least one property that differs by less than 10%.

Embodiment 16. The method of any of Embodiments 13-15, wherein the first build material and the second build material are provided in a layer-by-layer process.

Embodiment 17. The method of any of Embodiments 13-16, wherein the first build material and the second build material are selectively consolidated or solidified according to preselected computer aided design (CAD) parameters.

Embodiment 18. The method of any of Embodiments 13-17, wherein layers of the first build material are selectively consolidated or solidified and layers of the second build material are selectively consolidated or solidified using the same printing parameters.

Embodiment 19. The method of any of Embodiments 13-18, wherein selectively consolidating or solidifying layers of the first build material and layers of the second build material comprises selectively photocuring a portion of the first build material and selectively photocuring a portion of the second build material using incident curing radiation having a Gaussian distribution of wavelengths and a peak wavelength at the wavelength λ.

Embodiment 20. The method of any of Embodiments 13-18, wherein providing the first build material comprises retaining the first build material in a fluid state in a first container; and providing the second build material comprises retaining the second build material in a fluid state in a second container.

Embodiment 21. The method of any of Embodiments 13-18, wherein selectively consolidating or solidifying layers of the first build material and layers of the second build material comprises sintering the layers of the first build material and the layers of the second build material.

Embodiment 22. The method of any of Embodiments 13-18, wherein selectively consolidating or solidifying layers of the first build material and layers of the second build material comprises depositing layers of the first build material and layers of the second build material in a molten or fluid state and subsequently freezing or partially freezing the layers of the first build material and the layers of the second build material.

Embodiment 23. The method of any of Embodiments 13-18, wherein selectively consolidating or solidifying layers of the first build material and layers of the second build material comprises melting and subsequently refreezing or partially refreezing the layers of the first build material and the layers of the second build material.

Embodiment 24. The method of any of Embodiments 13-23, wherein the method further comprises providing n additional build materials, and selectively consolidating or solidifying layers of the n additional build material to form the article, wherein the n additional build materials do not have the same chemical compositions as the first build material, the second build material, or one another; and wherein n is an integer ranging from 1 to 100.

Embodiment 25. A printed three-dimensional article formed from the kit of any of Embodiments 1-12.

Embodiment 26. A system for printing a three-dimensional article comprising a first build material and a second build material as recited in the kit according to any of Embodiments 1-11.

All patent documents referred to herein are incorporated by reference in their entireties. Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A kit for use in additive manufacturing, the kit comprising:
a first build material; and
a second build material,
wherein the first build material and the second build material do not have identical chemical compositions;
wherein the first build material has a first surface tension and/or first wettability at a temperature T;
wherein the second build material has a second surface tension and/or second wettability at the temperature T;
wherein the first surface tension and/or first wettability and the second surface tension and/or second wettability, respectively, differ by 10% or less;
wherein the first build material has a first chemical reactivity at the temperature T, a first melting point onset temperature, and/or a first total optical absorbance or light penetration depth at a wavelength λ;
wherein the second build material has a second chemical reactivity at the temperature T, a second melting point onset temperature, and/or a second total optical absorbance or light penetration depth at the wavelength λ;
wherein the first chemical reactivity at the temperature T, the first melting point onset temperature, and/or the first total optical absorbance or light penetration depth at the wavelength λ, and the second chemical reactivity at the temperature T, the second melting point onset temperature, and/or the second total optical absorbance or light penetration depth at the wavelength λ, respectively, differ by 10% or less.

2. The kit of claim 1, wherein:
the first build material has a first surface tension at a temperature T, a first photocuring working curve at a wavelength λ, a first penetration depth (Dₚ) at the wavelength λ, and a first critical energy (E_{c}) at the wavelength λ;
the second build material has a second surface tension at the temperature T, a second photocuring working curve at the wavelength λ, a second Dₚ at the wavelength λ, and a second E_{c} at the wavelength λ;
the first surface tension differs from the second surface tension by 10% or less;
the first photocuring working curve and the second photocuring working curve intersect at a point having an x-value of 3 to 40 mJ/cm² and a y-value of 50 mils or less, or have slopes that differ by 1 mil or less from one another;
the first Dₚ is between 2 and 7 mils;
the second Dₚ is between 4 and 10 mils;
the first E_{c} is between 4 and 20 mJ/cm²; and
the second E_{c} is between 8 and 25 mJ/cm².

3. The kit of claim 2, wherein:
the first build material is a first polymerizable liquid; and
the second build material is a second polymerizable liquid that differs from the first polymerizable liquid.

4. The kit of claim 3, wherein the first polymerizable liquid, when cured, and the second polymerizable liquid, when cured, have at least one property that differs by at least 20%.

5. The kit of claim 4, wherein the first polymerizable liquid, when cured, and the second polymerizable liquid, when cured, have at least one property that differs by less than 10%.

6. The kit of claim 1, wherein the second build material comprises at least one supplemental component that is not present in the first build material.

7. The kit of claim 6, wherein:
the first build material and the second build material have identical chemical compositions, except for the supplemental component of the second build material.

8. The kit of claim 6, wherein the supplemental component is present in the second build material in an amount of up to 30 wt. %, based on the total weight of the second build material.

9. The kit of claim 3, wherein the first build material and/or the second build material comprises:
up to 80 wt. % oligomeric curable material;
up to 80 wt. % monomeric curable material; and
up to 10 wt. % photoinitiator; and
up to 40 wt. % one or more additional components, based on the total weight of the first build material and/or based on the total weight of the second build material.

10. The kit of claim 3, wherein:
the first build material comprises, based on the total weight of the first build material:
up to 80 wt. % oligomeric curable material;
up to 80 wt. % monomeric curable material; and
up to 10 wt. % photoinitiator; and
up to 40 wt. % one or more additional components; and
the second build material comprises, based on the total weight of the second build material:
up to 80 wt. % oligomeric curable material;
up to 80 wt. % monomeric curable material; and
up to 10 wt. % photoinitiator;
up to 40 wt. % one or more additional components; and
up to 30 wt. % supplemental component that is not present in the first build material.

11. The kit of claim 10, wherein:
the oligomeric curable material of the first build material and the second build material are the same or different;
the monomeric curable material of the first build material and the second build material are the same or different;
the photoinitiator of the first build material and the second build material are the same or different; and
the one or more additional components of the first build material and the second build material are the same or different.

12. The kit of claim 2, further comprising:
n additional build materials having n additional surface tensions at the temperature T, n additional photocuring working curves at the wavelength λ, n additional Dₚ values at the wavelength λ, and n additional E_{c} values at the wavelength λ,
wherein the n additional build materials do not have the same chemical compositions as the first build material, the second build material, or one another;
wherein the n additional surface tensions differ from the first surface tension, the second surface tension, and one another by 10% or less;
wherein the n additional photocuring working curves intersect with the first photocuring working curve, the second photocuring working curve, and with each other at a point having an x-value of 3 to 40 mJ/cm² and a y-value of 50 mils or less, or have slopes that differ by 1 mil or less from the first working curve, the second working curve, or one another;
wherein the n additional Dₚ values are each between 4 and 8 mils;
wherein the n additional E_{c} values are each between 4 and 25 mJ/cm²; and
wherein n is an integer ranging from 1 to 100.

13. A method of printing a three-dimensional article comprising:
providing a first build material and a second build material according to claim 1; and
selectively consolidating or solidifying layers of the first build material and layers of the second build material to form the article.

14. The method of claim 13, wherein:
selectively consolidating or solidifying layers of the first build material and layers of the second build material comprises forming regions of a first type and regions of a second type within the article; and
the regions of the first type and the regions of the second type have at least one property that differs by at least 20%.

15. The method of claim 14, wherein:
the regions of the first type and the regions of the second type have at least one property that differs by less than 10%.

16. The method of claim 13, wherein the first build material and the second build material are provided in a layer-by-layer process.

17. The method of claim 13, wherein the first build material and the second build material are selectively consolidated or solidified according to preselected computer aided design (CAD) parameters.

18. The method of claim 13, wherein layers of the first build material are selectively consolidated or solidified and layers of the second build material are selectively consolidated or solidified using the same printing parameters.

19. The method of claim 13, wherein selectively consolidating or solidifying layers of the first build material and layers of the second build material comprises selectively photocuring a portion of the first build material and selectively photocuring a portion of the second build material using incident curing radiation having a Gaussian distribution of wavelengths and a peak wavelength at the wavelength λ.

20. The method of claim 13, wherein the method further comprises:
providing n additional build materials; and
selectively consolidating or solidifying layers of the n additional build material to form the article,
wherein the n additional build materials do not have the same chemical compositions as the first build material, the second build material, or one another; and
wherein n is an integer ranging from 1 to 100.
